(19) United States
(12) Patent Application Publication
(10) Pub. No.: US 2023/0259594 A1
(43) Pub. Date: Aug. 17, 2023

(54) CONTROL SYSTEMS AND TECHNIQUES FOR SECURE OBJECT AUTHENTICATION

(71) Applicant: QUALCOMM Incorporated, San Diego, CA (US)

(72) Inventors: Dashan GAO, San Diego, CA (US); Lei WANG, San Diego, CA (US); Ning BI, San Diego, CA (US); Mithun Kumar RANGANATH, Poway, CA (US); Chun-Ting HUANG, San Diego, CA (US); Scott RUSNAK, San Diego, CA (US); David NEAL, Mesa, AZ (US)

(21) Appl. No.: 17/670,183

(22) Filed: Feb. 11, 2022

(51) Int. Cl. G06F 21/32; G06V 40/16; H04L 9/32

(52) U.S. Cl. CPC G06F 21/32; G06V 40/16; H04L 9/3231; H04L 9/3236; G06F 2221/2141

(57) ABSTRACT

Disclosed are systems, apparatuses, processes, and computer-readable media to implement a heterogenous biometric authentication process in a control system. For example, a method may include detecting the presence of a first person at a first time period and in an area associated with a function controlled by a control system. The method may include transmitting an authentication request to a first device detected by the control system, and receiving an authentication response from the first device. The authentication response includes information related to a biometric authentication performed at the first device. The method may further include authenticating the first person in the control system based on the information related to the biometric authentication. The method may then perform the function based on the authentication.

### FIELD

The present disclosure generally relates to object authentication. For example, aspects of the present disclosure are related to control systems and techniques for providing secure object authentication.

### BACKGROUND

Object authentication and/or verification can be used to authenticate or verify an object. For example, biometric-based authentication processes can be used for authenticating people. Biometric-based authentication can be used for various purposes, such as providing access to places and/or electronic devices. Examples of biometric-based authentication include face authentication, fingerprint authentication, voice authentication, among others.

Face authentication, for example, can compare a face of a device user in an input image with known features of the person the user claims to be, in order to authenticate that the user of the device is, in fact, the person. A similar process can be performed for fingerprint authentication, voice authentication, and other biometric-based authentication processes.

### SUMMARY

Systems and techniques are described herein that provide secure object authentication. According to at least one example, a method is provided for authenticating users with biometric-based information. The method includes: detecting the presence of a first person at a first time period and in an area associated with a function controlled by a control system; transmitting an authentication request to a first device detected by the control system; receiving an authentication response from the first device, the authentication response including information related to a biometric authentication performed at the first device; authenticating the first person in the control system based on the information related to the biometric authentication; and performing the function based on the authenticating of the first person.

In another example, an apparatus for authenticating users with biometric-based information is provided that includes a memory (e.g., configured to store data, such as virtual content data, one or more images, etc.) and one or more processors (e.g., implemented in circuitry) coupled to the memory. The one or more processors are configured to and can: detect the presence of a first person at a first time period and in an area associated with a function controlled by a control system; transmit an authentication request to a first device detected by the control system; receive an authentication response from the first device, the authentication response including information related to a biometric authentication performed at the first device; authenticate the first person in the control system based on the information related to the biometric authentication; and perform the function based on the authenticating of the first person.

In another example, a non-transitory computer-readable medium is provided that has stored thereon instructions that, when executed by one or more processors, cause the one or more processors to: detect the presence of a first person at a first time period and in an area associated with a function controlled by a control system; transmit an authentication request to a first device detected by the control system; receive an authentication response from the first device, the authentication response including information related to a biometric authentication performed at the first device; authenticate the first person in the control system based on the information related to the biometric authentication; and perform the function based on the authenticating of the first person.

In another example, an apparatus for authenticating users with biometric-based information is provided. The apparatus includes: means for detecting the presence of a first person at a first time period and in an area associated with a function controlled by a control system; means for transmitting an authentication request to a first device detected by the control system; means for receiving an authentication response from the first device, the authentication response including information related to a biometric authentication performed at the first device; means for authenticating the first person in the control system based on the information related to the biometric authentication; and means for performing the function based on the authenticating of the first person.

In some aspects, one or more of the methods, apparatuses, and computer-readable medium described above further comprise: capturing an image of the first person with an image sensor; and extracting biometric information of the first person from the image.

In some aspects, the biometric information includes facial information of the first person.

In some aspects, one or more of the methods, apparatuses, and computer-readable medium described above further comprise: identifying a second person in the image, wherein authenticating of the first person is further based on an authentication of the second person, and wherein the function is performed based on whether the first person and the second person are authenticated.

In some aspects, one or more of the methods, apparatuses, and computer-readable medium described above further comprise: extracting facial information of the second person from the image.

In some aspects, the function is performed when the first person and the second person are authenticated.

In some aspects, the authentication request includes biometric information of the first person.

In some aspects, the authentication request includes biometric information of the first person. In some cases, the authentication response includes an authentication status indicating that a previous biometric authentication of the first person occurred at the first device within a time period before the first time period.

In some aspects, based on a determination that the authentication status indicates the previous biometric authentication occurred at the first device within the time period before the first time period, determining a first identifier in the authentication response corresponds to a second identifier associated with user information stored by the control system.

In some aspects, one or more of the methods, apparatuses, and computer-readable medium described above further comprise: generating the second identifier by cryptographically hashing a biometric-based identifier associated with the first person.

In some aspects, the second identifier is generated based on a determination that the authentication response indicates the biometric information in the authentication request corresponds to stored biometric information in the first device.

In some aspects, the generating of the second identifier is performed based on a time domain function.

In some aspects, one or more of the methods, apparatuses, and computer-readable medium described above further comprise: identifying first user information of the first person, wherein the first user information includes the biometric-based identifier.

In some aspects, one or more of the methods, apparatuses, and computer-readable medium described above further comprise: based on a determination that the authentication status indicates the biometric information was not used to authenticate the first person within the time period, transmitting an authentication request to the first device to cause the first device to perform a biometric authentication of the first person using an input into the first device.

In some aspects, one or more of the methods, apparatuses, and computer-readable medium described above further comprise: receiving a first response to the authentication request including an authentication status indicating biometric information was used to authenticate the first person within a time period before the first time period; and transmitting an authentication request to the first device including the biometric information.

In some aspects, one or more of the methods, apparatuses, and computer-readable medium described above further comprise: broadcasting a beacon with information from a communication device of the control system; and determining a number of people proximate to the communication device based on at least one response to the beacon, wherein the function is performed based on the number of people proximate to the communication device.

In some aspects, the function is performed when a number of user devices that are authenticated by the control system is equal to the number of people proximate to the communication device.

In some aspects, the function is not performed when a number of user devices that are authenticated by the control system is different than the number of people proximate to the communication device.

In some aspects, the function is a supplemental authentication in a multiple authentication system, an access request to a restricted area, a financial transaction associated with a service, or an access event to a common area.

In some aspects, one or more of the methods, apparatuses, and computer-readable medium described above further comprise: receiving biometric information of the first person during registration of the first user information; generating the biometric-based identifier at least in part by combining a portion of features from the biometric information; and transmitting the biometric-based identifier to the control system.

According to at least one other example, a method is provided at a user device for communicating with a control system for biometric authentication. The method includes: receiving, from a control system, an authentication request including biometric information at a first time period; performing a biometric authentication of the biometric information by determining the biometric information corresponds to stored biometric information in the user device; generating a biometric-based identifier at least in part by combining the biometric information with identification information; and transmitting an authentication response to the control system, the authentication response including information related to the biometric authentication of the biometric information and information associated with the biometric-based identifier.

In another example, an apparatus for communicating with a control system for biometric authentication is provided that includes a memory (e.g., configured to store data, such as virtual content data, one or more images, etc.) and one or more processors (e.g., implemented in circuitry) coupled to the memory. The one or more processors are configured to and can: receiving, from a control system, an authentication request including biometric information at a first time period; perform a biometric authentication of the biometric information by determining the biometric information corresponds to stored biometric information in the user device; generate a biometric-based identifier at least in part by combining the biometric information with identification information; and transmit an authentication response to the control system, the authentication response including information related to the biometric authentication of the biometric information and information associated with the biometric-based identifier.

In another example, a non-transitory computer-readable medium is provided that has stored thereon instructions that, when executed by one or more processors, cause the one or more processors to: receive, from a control system, an authentication request including biometric information at a first time period; perform a biometric authentication of the biometric information by determining the biometric information corresponds to stored biometric information in the user device; generate a biometric-based identifier at least in part by combining the biometric information with identification information; and transmit an authentication response to the control system, the authentication response including information related to the biometric authentication of the biometric information and information associated with the biometric-based identifier.

In another example, an apparatus for communicating with a control system for biometric authentication is provided. The apparatus includes: receiving, from a control system, an authentication request including biometric information at a first time period; means for performing a biometric authentication of the biometric information by determining the biometric information corresponds to stored biometric information in the user device; means for generating a biometric-based identifier at least in part by combining the biometric information with identification information; and means for transmitting an authentication response to the control system, the authentication response including information related to the biometric authentication of the biometric information and information associated with the biometric-based identifier.

In some aspects, one or more of the methods, apparatuses, and computer-readable medium described above further comprise: generating the information associated with the biometric-based identifier by hashing the biometric-based identifier based on a time domain function.

In some aspects, one or more of the methods, apparatuses, and computer-readable medium described above further comprise: determining an authentication status indicating a previous biometric authentication occurred at the user device within a time period before the first time period.

In some aspects, the authentication request is received based on proximity to a sensor of a control system.

In some aspects, one or more of the methods, apparatuses, and computer-readable medium described above further comprise: receiving a request to perform biometric authentication at the user device; requesting biometric authentication at the user device; performing the biometric authentication at the user device based on an input; and transmitting information related to the biometric authentication at the user device to the control system.

In some aspects, the biometric information includes information associated with a different person detected by the control system.

In some aspects, one or more of the methods, apparatuses, and computer-readable medium described above further comprise: receiving biometric information of a first person during registration of first user information corresponding to a first user associated with the authentication request; generating the biometric-based identifier at least in part by combining a portion of features from the biometric information; and transmitting the biometric-based identifier to the control system.

In some aspects, one or more of the apparatuses described above is, is part of, and/or includes a wireless communication device such as a mobile device (e.g., a mobile telephone and/or mobile handset and/or so-called “smart phone” or other mobile device), a wearable device, an extended reality (XR) device (e.g., a virtual reality (VR) device, an augmented reality (AR) device, or a mixed reality (MR) device), a camera, a personal computer, a laptop computer, a server computer, a control system or control console, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of a person being authenticated for unlocking a mobile device based on one or more images captured by a camera of the mobile device, in accordance with some aspects;

FIG. 2 is a diagram illustrating an example control system that uses an external biometric verification to perform a biometric authentication, in accordance with some aspects;

FIG. 3 is a flowchart illustrating an example of a process implemented by a control system that provides biometric information to a user device to perform an external biometric verification, in accordance with some aspects;

FIG. 4 is a flowchart illustrating an example of a process implemented by a user device that receives captured biometric information from a control system and performs a biometric verification of the captured biometric information, in accordance with some aspects;

FIG. 5 is a sequence diagram of a heterogenous biometric authentication process that is performed by a user device and a control system, in accordance with some aspects;

FIG. 6 is a sequence diagram of a heterogenous biometric authentication process that is performed by a user device and a control system, in accordance with some aspects;

FIG. 7 is a sequence diagram of a heterogenous biometric authentication process that is performed by a user device and a control system that requires a supplemental biometric authentication at the user device, in accordance with some aspects;

FIG. 8 is a sequence diagram of a heterogenous biometric authentication process that is performed by a user device and a control system that separately transmits biometric authentication based on recent biometric authentication at the user device, in accordance with some aspects;

FIG. 9 is a sequence diagram of a heterogenous biometric authentication process that is performed by a control system in conjunction with user device and user device, in accordance with some aspects;

FIG. 10 is a sequence diagram of a heterogenous authentication process performed by a control system, in accordance with some aspects;

FIG. 11 is a flowchart illustrating an example of a control system that can be used in a heterogeneous authentication process, in accordance with some aspects;

FIG. 12 illustrates an example sequence diagram of a heterogenous authentication process performed by a user device, in accordance with some aspects;

FIG. 13 is a flowchart illustrating an example of a user device that can be used in a heterogeneous authentication process, in accordance with some aspects;

FIG. 14 is a sequence diagram of a process to register user biometrics that can be used in a heterogeneous authentication process, in accordance with some aspects;

FIG. 15 is a flowchart illustrating an example of a process 1500 for performing biometric authentication in a control system, in accordance with some aspects;

FIG. 16 is a flowchart illustrating an example of a process 1600 for performing biometric authentication by a user device, in accordance with some aspects; and

FIG. 17 is a diagram illustrating an example of a system for implementing certain aspects described herein.

### DETAILED DESCRIPTION

Certain aspects of this disclosure are provided below. Some of these aspects and aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims

Object recognition can be defined as a process that is performed to verify that an identified object (e.g., a person, a badge, etc.) has the requisite credentials to access a system or device (e.g., a mobile device, a personal computer, a tablet computer, etc.) or to use a resource of a system (e.g., a door, an application programming interface (API) endpoint, etc.). For example, a user can be authenticated based on a security badge, and can be authorized to access specific floors in a multi-floor building. Object identification and object authentication (also referred to as object verification) are forms of object recognition and are used in different contexts.

Object identification refers to the identification of object information in a collection of object information based on an input (e.g., a one-to-many matching process). An object identification process identifies whether the best matching object information can be found in a collection of object information. An example of object identification is biometric identification, which uses biometric information such as a face, fingerprint, and so forth to identify a person. Biometric identification can be used to identify unknown biometric information such as, for example, searching a face in a criminal database. The biometric identification process can result in a false identification, indicating that there is no matching biometric information, or a positive identification. In some cases, a function corresponding to a biometric information can return a null object or value, or a false value to indicate that there is no matching biometric information. In some cases, the function can return a positive value, an object corresponding to the biometric information, or some other reference that corresponds to matching biometric information (e.g., a hash, an identifier, etc.).

Object authentication includes an identification of input object information to existing object information that a system is expecting (e.g., a one-to-one matching process). An object authentication process receives an object input (e.g., biometric information such as a face) and identifies whether that object input matches an expected object (e.g., one-to-one). An example of object authentication is biometric authentication, which can be used to check if a person is who they claim to be (e.g., to check if the person claimed is the person in an enrolled database of authorized users). Biometric authentication has many applications, such as for performing access control to a device (e.g., “unlocking” access to the device), system, place, or other accessible item.

Biometrics is the science of analyzing physical or behavioral characteristics specific to each individual, in order to be able to authenticate the identity of each individual. Biometric-based authentication processes can be used to authenticate people, such as to provide access to devices, systems, places, or other accessible items. In some cases, biometric-based authentication allows a person to be authenticated based on a set of templates (verifiable data), which are unique to the person. Examples of biometric-based authentication include face authentication, fingerprint authentication, voice authentication, among others. Face authentication, for example, can compare a face of a device user in an input image with known features (e.g., stored in one or more templates) of the person the user claims to be, in order to authenticate that the user of the device is, in fact, the person. A similar process can be performed for fingerprint authentication, voice authentication, and other biometric-based authentication processes.

Face identification can be used by a control system to control functions, such as a security gate, payment authorization, etc. Facial identification solutions use a centralized database to store all users' facial images and use detected facial features to identify a particular user in the database. Performance of facial identification is directly related to the size of the database. For example, each biometric information in the database must be compared to the captured biometric information, which increases the database size and the compute resources needed to perform the face identification. Adding additional access points further increases the compute requirements and computational costs associated with face identification. A large centralized database of face information also provides security concerns because a data breach can compromise privacy of all users. The database of facial information is also difficult to keep up to date.

As noted above, face authentication is a solution for a single device to perform authentication at a user device and uses a one-to-one matching process to determine the veracity of a person's face. Face authentication provides a low computation burden that can be performed with low latency. For example, face authentication may not require a centralized database and can be used to identify whether a detected face corresponds to an expected face. Because there is no centralized database, personal information associated with the user is stored on that user's device. Further, any data breach of a user's device will only leak information included on that user's device.

Systems, apparatuses, processes (or processes), and computer-readable media (referred to collectively as “systems and techniques”) are described herein that provide a control system that provides secure object authentication. The control system can include a heterogenous control system that preserves privacy of users' biometric information. The systems and techniques can be used for any biometric-based authentication, including, but not limited to, face authentication, fingerprint authentication, voice authentication, any combination thereof, or any other type of biometric-based authentication.

In some examples, the control system can communicate with a user device to perform authentication. For example, the control system can detect biometric information of a user (e.g., by capturing an image of the user and extracting facial features) and can communicate the biometric information to a device of the user. The user device can perform a biometric authentication (e.g., face authentication) based on the biometric information provided by the control system. The user device can communicate a result of the biometric authentication to the control system, such as a positive or negative authentication result. In some aspects, the control system and the user device can utilize a unique identifier that is based on biometric information (e.g., a biometric-based identifier) of the user to verify the authenticity of messages transmitted between the control system and the user devices.

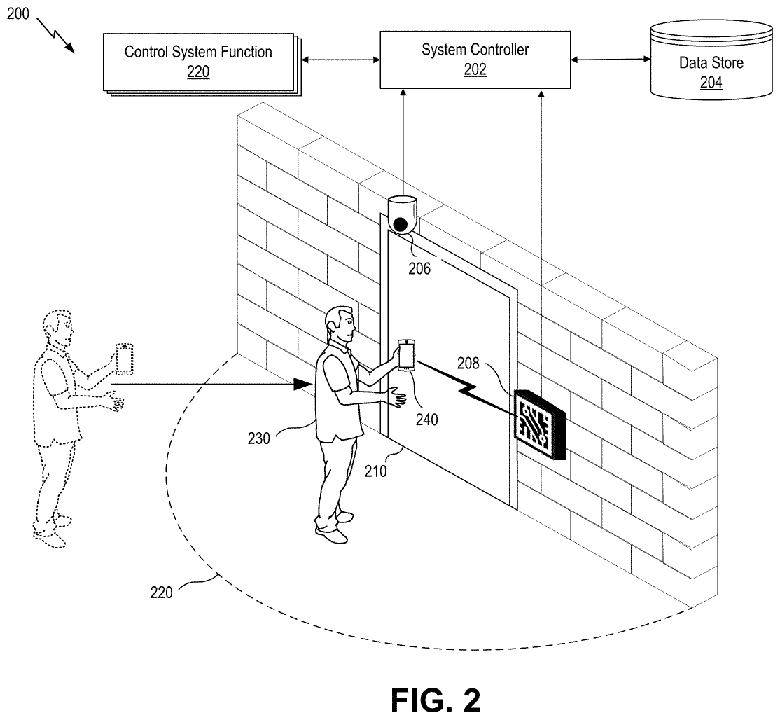

The control system improves the quality of biometric authentications, reduces compute complexity, and increases privacy. Further details regarding the heterogenous control system are described below with respect to FIG. 2-FIG. 13.

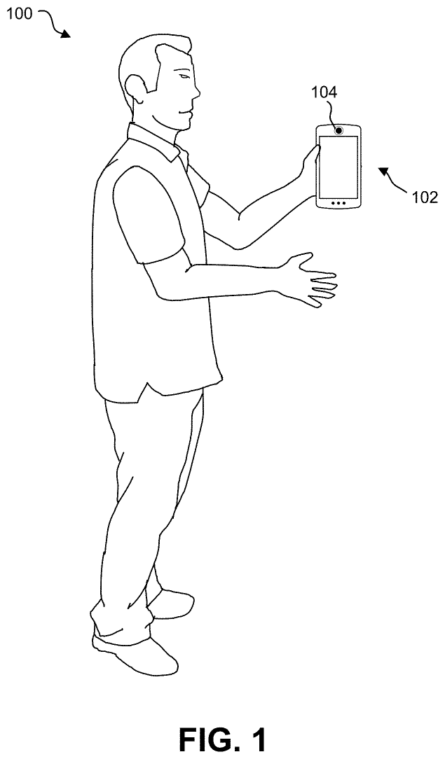

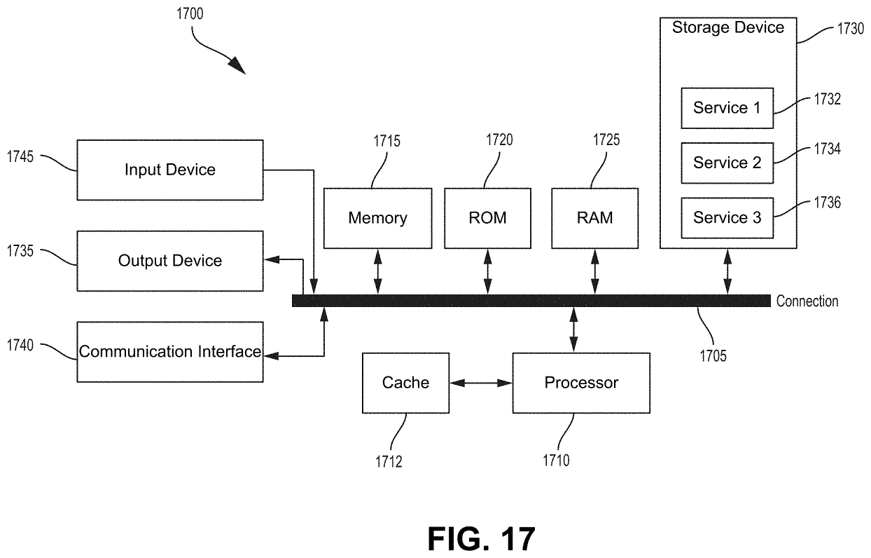

FIG. 1 is a diagram illustrating an example of a user 100 using a mobile device 102. In some examples, the mobile device 102 is a mobile phone (e.g., a smartphone with Internet and voice capabilities). In some implementations, the mobile device 102 has a system architecture similar to the computing system 1700 described below with respect to FIG. 17. In addition, the mobile device includes a front-facing camera 104 that is configured to and can capture images of a physical scene or environment within a field-of-view (FOV) of the front-facing camera 104.

In some examples, the front-facing camera 104 is an always-on (AON) camera. An AON camera is a low-power camera that passively captures images without requiring explicit instruction (e.g., based on user input) requesting the capture of the images. In some cases, the front-facing camera 104 (as an AON camera) can have a lower frame-rate and can thus capture fewer images than the frame-rate of a non-AON camera. In some examples, the images captured by the front-facing camera 104 (as an AON camera) are not stored except for performing object authentication (e.g., face authentication). For instance, the images captured by the front-facing camera 104 (as an AON camera) can be temporarily cached for use by one or more processors for performing face authentication.

In some cases, the front-facing camera 104 (as an AON camera) can only be activated to start capturing images when a scene change is detected. In one illustrative example, a scene change can be detected when a change in pixel data above a scene change threshold is detected. The scene change threshold can be based on the amount of pixels in a first image that is different than corresponding pixels (at common locations) in a second image or multiple images. For instance, if at least 20% of the pixels in the first image are different than the corresponding pixels (at common locations) in the second image are different, a scene change can be detected. In some cases, the front-facing camera 104 (as an AON camera) can only be activated to start capturing images when motion is detected. In some examples, motion can be detected using an optical motion sensor of the mobile device 102, an accelerometer, a gyroscope, an inertial measurement unit (IMU), and/or other sensor or component of the mobile device 102.

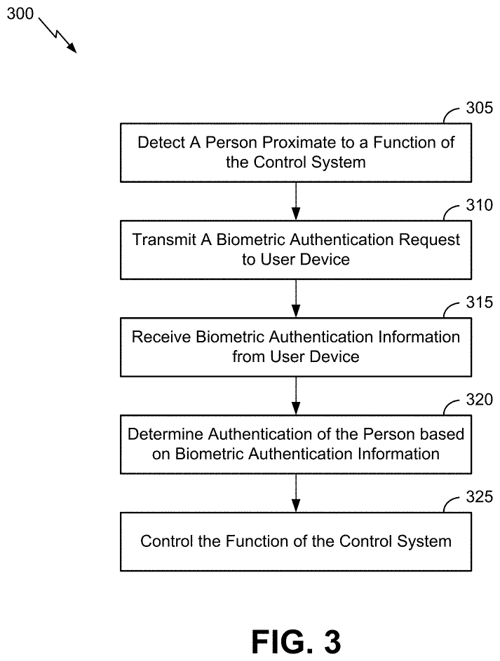

The front-facing camera 104 can capture images of the user 100 and one or more processors of the mobile device 102 can perform face authentication in order to determine whether the user 100 is authorized to access (to “unlock”) the mobile device 102. In some examples, face authentication can be performed by comparing the face of the user 100 in one or more input images with known features (e.g., stored in one or more templates) of the person the user claims to be. If enough features of the face of the user 100 match the features stored in one or more of the templates, the one or more processors will authenticate that the user of the device is an authorized user of the mobile device 102 and is thus authorized to unlock or access the mobile device 102. Various heterogeneous authentication processes are described below with respect to FIGS. 3 to 13 that can employ a mobile device 102 to perform biometric authentication for a control system and authorize a user of the mobile device 102 to perform a function.

FIG. 2 is a diagram illustrating an example control system 200 for enrolling a user device to perform a secure biometric authentication and perform a function associated with the control system. The control system 200 may be configured to not store a user's biometric information that, if leaked, could be used for malicious purposes. In some examples, the control system 200 provides information to a user's device and that authenticates the user's biometrics. The control system receives a response from the user device and can then authenticate the user in the control system 200.

In some aspects, the control system 200 includes a system controller 202, a data store 204, and a plurality of external sensors such as an image sensor 206 and a communication device 208. Although FIG. 2 illustrates two different sensors, any number of sensors can be combined into the control system 200 to identify a person (or people), detect motion, and perform various supporting authentication functions. For example, the communication device 208 can be a wireless device configured to connect to user devices using one or more wireless communication protocols. Examples of a wireless protocol include Bluetooth Low Energy (BLE), WiFi, Zigbee, radio frequency identification (RFID), etc. In some aspects, the control system 200 can include an infrared (IR) motion sensor, ultrasound motion sensor, or other suitable motions detectors to identify movement. The control system 200 can include various sensors such as a fingerprint sensor, a dot projector, and so forth that can provide a notification that a person is present.

In the example illustrated in FIG. 2, the control system 200 is configured to control a function based on authentication. In the example illustrated in FIG. 2, the control system 200 is configured to control access to a door 210 (e.g., unlock the door 210 or keep the door 210 locked) based on detecting proximity of a person within a detection range 220 of the control system. In some aspects, the various sensors of the control system 200 can have a different detection range 220 and may be able to identify whether a person is moving towards the door 210. For example, the communication device 208 may be configured to transmit an 802.11k beacon to identify nearby devices and receive responses that allow the communication device 208 to ascertain a user 230 having a user device 240 are moving towards the communication device 208 based on a change to path loss between the user device 240 and the communication device 208. For example, if path loss decreases and the received signal strength indicator (RSSI) at the 240 is less than a fixed threshold, the communication device 208 may determine that the user 230 is within the detection range 220. In other examples, the image sensor 206 may detect objects within a captured image and determine a distance between the image sensor 206 and the user 230.

Once the user 230 is detected, the sensors (e.g., the image sensor 206, the communication device 208, etc.) can inform the system controller 202 that a person is within a range for accessing the function (e.g., unlocking the door 210). The system controller 202 can use one of the sensors (e.g., the image sensor 206, the communication device 208, etc.) to capture biometric information associated with the user 230. In some aspects, the system controller 202 may activate the image sensor 206 to capture at least one image of the user 230. In some other aspects, the user 230 may be detected based on an input into a sensor such as a fingerprint sensor that captures the biometric information (e.g., a fingerprint) and also indicates the presence of the user 230 proximate to the controlled function (e.g., the door 210). The control system 200 may also be configured to setup a wireless connection to the user 230 to communicate (e.g., send and receive) information.

In some aspects, the control system 200 is configured to not store any captured biometric information (e.g., a fingerprint, a face, etc.) of the user 230. In place of biometric information, the control system 200 is configured to determine a biometric-based identifier that is created using a one-way function during user enrollment. The biometric-based identifier is only shared during enrollment (e.g., user registration) and can be used by the control system 200 and the user device 240 to verify the authenticity of messages transmitted between the control system 200 and the user device 240.

The control system 200 can be configured to transmit captured biometric information (e.g., at least one image captured by the image sensor 206) to the user device 240. The user device 240 may then use the captured biometric information from the control system 200 to perform a biometric verification that the captured biometric information from the control system 200 matches stored biometric information in the user device 240. Based on the biometric verification of the captured biometric information from the control system 200, the user device 240 can transmit a response indicating that the captured biometric information matches the stored biometric information. This informs the control system 200 that the captured biometric information would authenticate the user at the user device 240, and control system 200 ascertains can then authenticate the user. In some aspects, the control system 200 can also use additional information from the user 230 to determine the authentication result.

FIG. 3 is a flowchart illustrating an example of a process 300 implemented by a control system (e.g., the control system 200) that provides biometric information to a user device (e.g., the user device 240) to perform an external biometric verification. At block 305, the control system can detect that a person is proximate to a function of the control system. For example, a motion sensor can detect motion that a user is within a detectable range and moves towards an access point (e.g., a function) controlled by the control system.

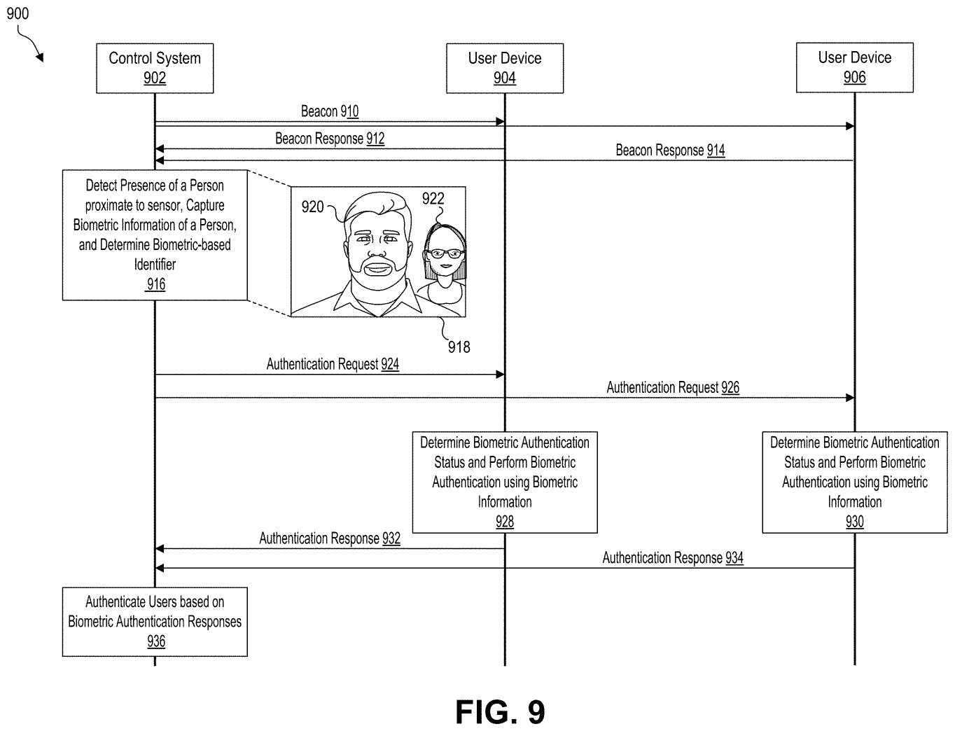

At block 310, the control system is configured to transmit a biometric authentication request to a user device based on a connection formed between the user device and a corresponding sensor near the access point. In some aspects, biometric authentication can include the captured biometric information of the user. In some other aspects, the sensor can detect that more than one person is present in a captured image and may extract biometric information from each person and transmit each biometric information to a plurality of devices. As will be described further below in connection with FIG. 9, the control system can require that each biometric information from the captured image be authenticated by a distinct user device to prevent unauthorized access.

At block 315, the control system is configured to receive biometric authentication information from the user device. The biometric authentication information can include a biometric verification of the biometric information that the control system captured and can also include a biometric authentication status of the user device. For example, the biometric authentication status can indicate that the user was authenticated by the user device a predetermined number of times (e.g., 3) within a predetermined time period (e.g., 4 hours). In some aspects, the biometric authentication information can also include an identifier that is used to authenticate the veracity of the biometric authentication information.

At block 320, the control system determines whether to authenticate the person based on the biometric authentication information. The control system can use different authentication requirements to determine whether is person is authentication, as further described below in FIGS. 3 to 9.

When the user is authenticated at block 320, the control system controls the function at block 325. For example, as illustrated in FIG. 2, the control system can be configured to unlock a door 210 to allow the user to access a secured area. The function could be any location-based function such as a ticketing system, a monitoring system, a surveillance system, and so forth. The function is not limited to location-based functions and may be applied to any controlled function such as an authentication system used to grant access to a network function, a multifactor authentication system to verify access credentials, etc.

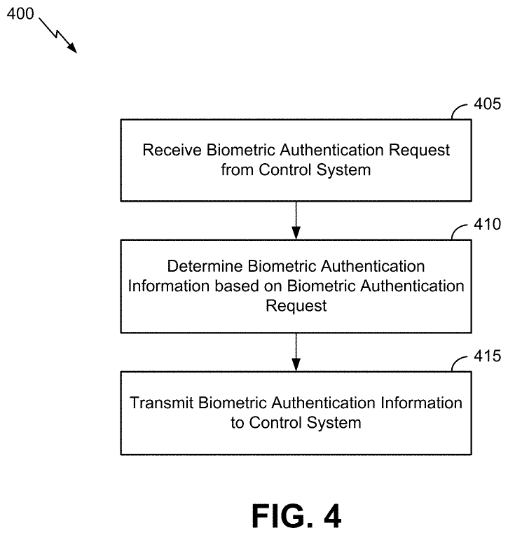

FIG. 4 is a flowchart illustrating an example of a process 400 implemented by a user device that receives captured biometric information from a control system and performs a biometric verification of the captured biometric information, in accordance with some examples. The user device (e.g., the user device 240) is presumed to be connected to a communication device of a control system (e.g., the control system 200) and receives a biometric authentication request from the control system at block 405. In some aspects, the biometric authentication request can include biometric information captured at the control system. The biometric request can also request a biometric authentication status of a user at the user device.

At block 410, the user device can determine biometric authentication information based on the biometric authentication request. The biometric authentication information can vary and include information such as the biometric authentication status and provides information related to recent biometric authentications at the user device. The biometric authentication information can also include information related to biometric verifications using external information (e.g., biometric information captured by the control system).

At block 415, the user device can transmit the biometric authentication information to the control system. In response, the control system can determine the authentication of the user and control a function for the user of the user device.

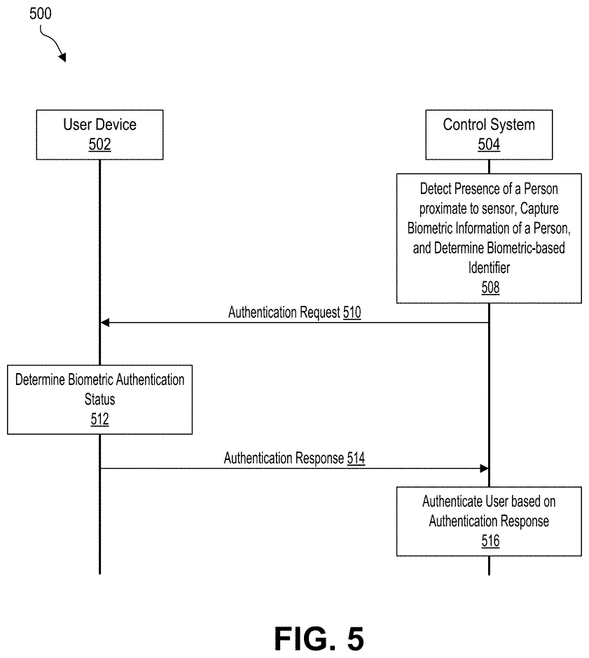

FIG. 5 illustrates an example sequence diagram of a heterogenous biometric authentication process 500 that is performed by a user device 502 and a control system 504. In the heterogenous biometric authentication process 500 depicted in FIG. 5, the captured biometric information at the control system 504 is not shared with the user device 502 and authentication status of the user at the user device 502 is used to determine an authentication result at the heterogenous biometric authentication process 500.

At block 508, the control system 504 detects the presence of a person proximate to a sensor of the control system 504, captures biometric information of the person, and determines a biometric-based identifier of the biometric information. The biometric-based identifier may be a combination of the biometric information of unique identification information (e.g., a user identifier, a hardware identifier associated with the user device 502 such as a media access control (MAC) address, an International Mobile Subscriber Identity (IMSI) number, etc.). The control system 504 performs a one-way function that extracts portions of the biometric information and combines the portion of the biometric information with the unique identification information to generate the biometric-based identifier. The control system 504 may perform an initial assessment of authentication by attempting to identify user information based on the biometric-based information. When the control system 504 matches user information, the control system 504 would understand that the user information matches the biometric information. The biometric-based identifier is generated based on a one-way transform that removes portions of biometric information, and the biometric information cannot be restored from the biometric-based information.

The control system 504 transmits an authentication request 510 to the user device 502. In this example, the authentication request 510 includes a request for authentication status of the user device 502 and does not include biometric information captured by the control system 504. The user device 502 receives the authentication request 510 at block 512 and determines a biometric authentication status at the user device. For example, the user device can identify recent biometric authentications of the user (e.g., biometric authentication status) and generate biometric authentication status based on the recent biometric authentications of the user. The user device 502 may also cryptographically hash the biometric-based identifier stored by the user device 502. The user device transmits the biometric authentication status and the hashed biometric-based identifier in an authentication response 514, an example of which is depicted in Table 1 below in JavaScript object notation (JSON).

TABLE 1

```
{
  “hashedBiometricIdentifer”:
  “RklR4AlN7hSstMcg25teNKXsBAj1Co0podNu11tF”,
  “biometricAuthenticationStatus”:
  {
    “biometricAuthenticationStatusResult”: true,
    “lastBiometricAuthenticationTime: “2021-12-12T18:56:52+0000”,
    “biometricAuthenticationType”: “0”
  },
  “userId”: “9yLAS9X5T88DrbpeJEny”,
}
```

The control system 504 receives the authentication response 514 and determines whether to authenticate the user based on the biometric authentication status and the hashed biometric-based identifier at block 516. For example, the biometric authentication status can indicate that the user was biometrically authenticated by the user device a predetermined number of times within a predetermined time period. For example, if the user was not biometrically authenticated three different times within four hours, the control system 504 can determine that the user was not sufficiently authenticated at the user device and the authentication fails. The control system 504 may cryptographically hash the biometric-based identifier and compare the result with the hashed biometric-based identifier in the authentication response 514. If the hashed identifiers match, then the control system 504 determines that the authentication response 514 is authentic.

In some aspects, the biometric-based identifier is hashed using a salt that changes at a predetermined time interval (e.g., 30 minutes) and, if the hashed biometric-based identifier is intercepted, the validity of the intercepted identifier will expire.

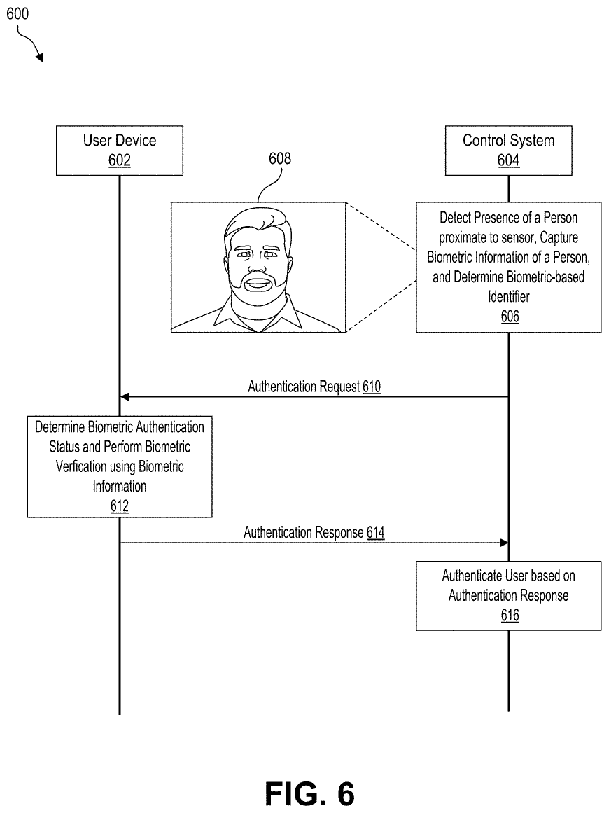

FIG. 6 illustrates an example sequence diagram of a heterogenous biometric authentication process 600 that is performed by a user device 602 and a control system 604. In the heterogenous biometric authentication process 600 depicted in FIG. 6, the captured biometric information at the control system 604 is shared with the user device 602 and the user device 602 performs a separate biometric authentication using the captured biometric information. The user device 602 can also determine an authentication status of the user at the user device 602 and transmit the results to the control system 604 to authenticate a user.

In particular, at block 606, the control system 604 detects the presence of a person proximate to a sensor of the control system 604, captures biometric information 608 of the person, and determines a biometric-based identifier of the biometric information. As described above, the biometric-based identifier may be a combination of the biometric information of unique identification information, and the control system 604 performs an initial assessment of authentication by attempting to identify user information based on the biometric-based information.

The control system 604 transmits an authentication request 610 to the user device 602. In this example, the authentication request 610 includes a request for an authentication status of the user device 602 and the captured biometric information 608.

The user device 602 receives the authentication request 610, determines a biometric authentication status at the user device, and performs a biometric verification based on the captured biometric information 608 at block 612. In some aspects, the user device 602 compares the captured biometric information 608 to stored biometric information in the user device 602 using an algorithm that matches biometric features. The user device 602 is the only device that stores information that is capable of matching biometric information of the user, and control system 604 transmits the captured biometric information to perform the biometric verification. In some aspects, the user device 602 identifies recent biometric authentications of the user (e.g., biometric authentication status) and generates biometric authentication status based on the recent biometric authentications of the user. The user device 602 also stores the biometric-based identifier and cryptographically hashes the biometric-based identifier for the control system 604. The user device 602 generates an authentication response 614 that includes various information such as a match result, the hashed biometric-based identifier, and authentication status information such as times of recent biometric authentication times. An example of an authentication response 614 is illustrated in Table 2 below.

TABLE 2

```
{
  “capturedBiometricVerificationResult”: true,
  “hashedBiometricIdentifer”:
  “RklR4AlN7hSstMcg25teNKXsBAj1Co0podNu11tF”,
  “biometricAuthenticationTimes”:
  [
    “2021-12-12T18:56:52+0000”,
    “2021-12-12T16:56:52+0000”,
    “2021-12-12T17:42:52+0000”
  ],
  “userId”: “9yLAS9X5T88DrbpeJEny”,
}
```

The user device 602 transmits the authentication response 614 to the control system 604. The control system 604 determines whether the user is authenticated at block 616 based on the various requirements. For example, the control system 604 uses the cryptographically hashed biometric-based identifier to verify the authenticity of messages to determine whether the contents can be trusted. In some aspects, the captured biometric verification result indicates that the user device 602 successfully verified the captured biometric information 608 matches the biometric information stored in the user device 602. The control system 604 can also use the biometric authentication status (e.g., the times of the biometric authentication illustrated in Table 2 above) to authenticate the user.

In the heterogenous biometric authentication process 600, the user device 602 is the only device that stores biometric information that can be used to identify the user. The control system 604 does not store this information, thereby preventing malicious actors with any unauthorized access from scraping this data for malicious use.

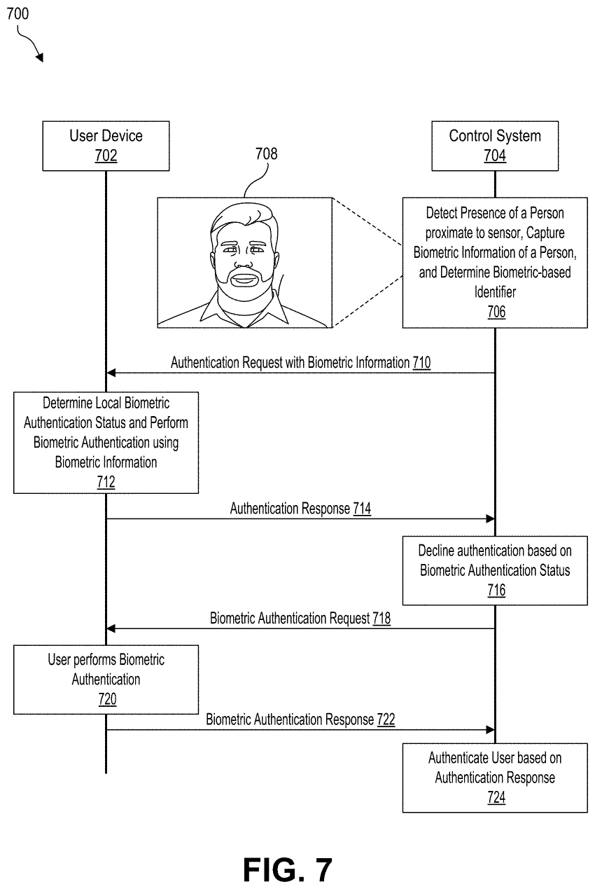

FIG. 7 illustrates an example sequence diagram of a heterogenous biometric authentication process 700 that is performed by a user device 702 and a control system 704 that requires a supplemental biometric authentication at the user device 702. In the heterogenous biometric authentication process 700 depicted in FIG. 7, the captured biometric information at the control system 704 is shared with the user device 702 and the user device 702 performs a separate biometric authentication using the captured biometric information. In some aspects, the control system 704 may request the user device 702 to perform a biometric authentication of the user.

At block 706, the control system 704 detects presence of a person proximate to a sensor of the control system 704, captures biometric information 708 of the person, and determines a biometric-based identifier of the biometric information. As described above, the biometric-based identifier may be a combination of the biometric information of unique identification information, and the control system 704 performs an initial assessment of authentication by attempting to identify user information based on the biometric-based information.

The control system 704 transmits an authentication request 710 to the user device 702. In this example, the authentication request 710 includes a request for an authentication status of the user device 702 and the captured biometric information 708.

At block 712, the user device 702 receives the authentication request 710, determines a biometric authentication status at the user device, and performs a biometric authentication (or verification) based on the captured biometric information 708. In some aspects, the user device 702 compares the captured biometric information 708 to stored biometric information in the user device 702 using an algorithm that matches biometric features. The user device 702 is the only device that stores information that is capable of matching biometric information of the user, and control system 704 transmits the captured biometric information to perform the biometric verification. In some aspects, the user device 702 identifies recent biometric authentications of the user (e.g., biometric authentication status) and generates biometric authentication status based on the recent biometric authentications of the user. The user device 702 also stores the biometric-based identifier and cryptographically hashes the biometric-based identifier for the control system 704. The user device 702 generates an authentication response 714 that includes various information such as a match result, the hashed biometric-based identifier, and authentication status information such as times of recent biometric authentication times. An example of an authentication response 714 is illustrated in Table 3 below.

TABLE 3

```
{
  “capturedBiometricVerificationResult”: true,
  “hashedBiometricIdentifer”:
  “RklR4AlN7hSstMcg25teNKXsBAj1Co0podNu11tF”,
  “biometricAuthenticationTimes”:
  [
    “2021-12-12T06:56:52+0000”,
    “2021-12-12T04:56:52+0000”,
    “2021-12-11T17:42:52+0000”
  ],
  “userId”: “9yLAS9X5T88DrbpeJEny”,
}
```

The user device 702 transmits the authentication response 714 to the control system 704. In some aspects, the control system 704 may decline to authenticate the user at block 716. In some other aspects, the control system 704 may require the user device 702 to perform a biometric authentication after receiving a sufficient authentication response 714. In some aspects, the control system may decline the authentication based on information in the authentication response 714 such as not satisfying a requirement associated with the biometric authentication status (e.g., the user was not biometrically authenticated at the user device within a predetermined time period.

The control system 704 transmits a biometric authentication request 718 to the user device 702 to request the user device 702 to perform a biometric authentication. In response, the user device 702 outputs a user interface to prompt the user to perform a biometric authentication at block 720. The user device 702 performs the authentication and transmits a biometric authentication response 722 including a result of the biometric authentication to the control system 704. The control system 704 authenticates the user based on the biometric authentication response 722 at block 724. For example, the user is not authenticated at block 724, the control system 704 determines that the user is not authenticated.

In the heterogenous biometric authentication process 700, the control system 704 can request a supplemental authentication. The supplemental authentication can be required by the control system 704 irrespective of biometric authentication status or can be required based on the biometric authentication status.

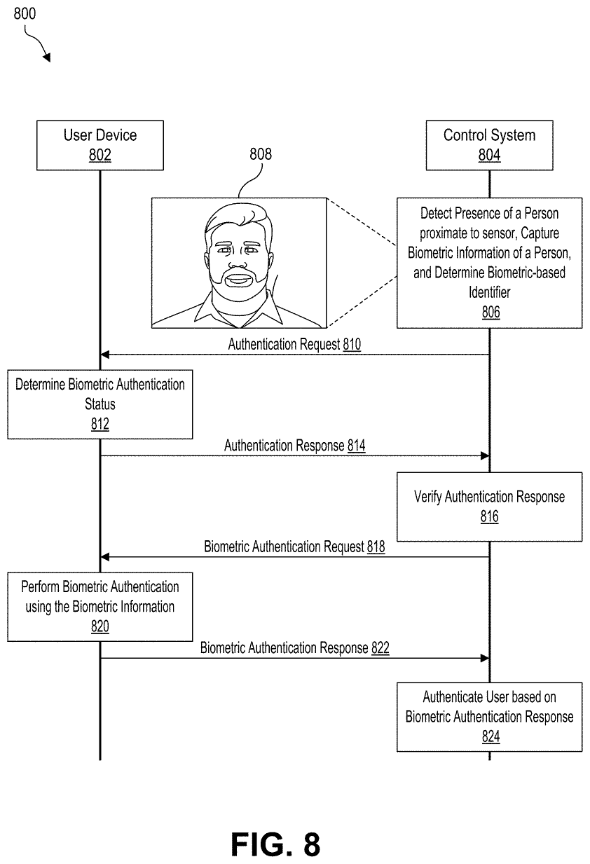

FIG. 8 illustrates an example sequence diagram of a heterogenous biometric authentication process 800 that is performed by a user device 802 and a control system 804 that transmits biometric authentication based on recent biometric authentication at the user device 802. In the heterogenous biometric authentication process 800 depicted in FIG. 8, the captured biometric information at the control system 804 is shared after the control system 804 receives the biometric authentication status of the user device 802.

At block 806, the control system 804 detects the presence of a person proximate to a sensor of the control system 804, captures biometric information 808 of the person, and determines a biometric-based identifier of the biometric information. As described above, the biometric-based identifier may be a combination of the biometric information of unique identification information, and the control system 804 performs an initial assessment of authentication by attempting to identify user information based on the biometric-based information.

The control system 804 transmits an authentication request 810 to the user device 802. In this example, the authentication request 810 includes a request for the authentication status of the user device 802. In this example, authentication request 810 does not include the captured biometric information 808.

The user device 802 receives the authentication request 810, determines a biometric authentication status at the user device at block 812. In some aspects, the user device 802 identifies recent biometric authentications of the user (e.g., biometric authentication status) and generates biometric authentication status based on the recent biometric authentications of the user. In some aspects, the user device 802 can determine that the recent biometric authentications will not satisfy a requirement, which can be explicitly identified in the authentication request 810 or can be configured by the user device 802. In that case, the user device 802 may request a biometric authentication as part of block 812. The user device 802 generates and transmits an authentication response 814 to the control system 804, and the authentication response 814 can include a hashed biometric-based identifier.

In response to the authentication response 814, the control system 804 verifies the authentication response 814 using the hashed biometric-based identifier at block 816. In response to verifying the authentication response 814, the control system 804 transmits a biometric authentication request 818 including the captured biometric information 808 to the user device 802. In response, the user device 802 performs the biometric authentication using the captured biometric information from the control system 804 at block 820. The user device generates and transmits a biometric authentication response 822 to the control system 804. In response to the biometric authentication response 822, the control system 804 authenticates the user based on biometric authentication response 822 at block 824.

FIG. 9 illustrates an example sequence diagram of a heterogenous biometric authentication process 900 that is performed by a control system 902 in conjunction with user device 904 and user device 906. In the heterogenous biometric authentication process 900 depicted in FIG. 9, the control system 902 identifies the presence of multiple people and determines to perform the function based on whether each person is authenticated. In other aspects, the control system 902 may perform the function with a single person is authenticated. For example, if the control system 902 is an access control system at a rental property, the control system 902 can identify a single user to provide access.

The control system 902 is configured to transmit a beacon 910 within an area associated with a function of the control system 902. In some aspects, the control system includes an access controller that includes an image sensor and a communication device that uses various wireless communication protocols such as Bluetooth, WiFi, Zigbee, etc. The beacon 910 is transmitted periodically for other devices to receive and respond to.

In some aspects, a plurality of users of the control system 902 may physically approach the access point. A first user device 904 and a second user device 906 may each receive the beacon. The first user device 904 transmits a beacon response 912 to the control system 902 (e.g., the access point controller) and the second user device 906 transmits a beacon response 914 to the control system 902. The beacon response 912 and the beacon response 914 can include information such as a transmission power and the control system can determine a path loss to user device 904 and a path loss to the user device 906. Based on the path loss, the control system 902 can determine a distance and other information that can be used to detect proximity of each user.

In some aspects, the control system can detect the presence of at least one person adjacent to the access point, capture biometric information of at least one person, and determine a biometric-based identifier at block 916. In some aspects, the control system 902 may configure a connection to the user device 904 and another connection to the user device 906 (not shown) to exchange information based on detecting both the user device 904 and the user device 906 are moving towards the access controller. In response to the user devices 904 and 906 being within an estimated range, the control system 902 can activate a sensor to capture biometric information 918. The captured biometric information 918 is an image that includes facial information associated with a first person 920 and facial information of a second person 922.

At block 916, the control system 902 can determine that there are multiple people and authentication for each user must be performed for each user for the control system 902 to perform the function. The control system 902 generates and transmits an authentication request to each user device 904 and 906. For example, the control system 902 generates an authentication request 924, which is depicted in further detail in Table 4, that includes information that can be used by the user device 904 to authenticate the user associated with the user device 904.

TABLE 4

```
{
  “AuthenticationData”:
    [
      {
        “frameId”:“0”,
        “authenticationId”: “9”,
        “timestamp”:“2021-12-13T14:40:51+0000”,
        “frameData”: “ycdS4F9h04nkQ4C41g1d”,
      },
      {
        “frameId”:“5”,
        “authenticationId”: “2”
        “hashedBiometricIdentifer”:“ Uzwhb5UpdBgTsIsRww3T”,
        “timestamp”:“ 2021-12-13T14:40:51+0020”,
        “frameData”: “dsb0A8OE546b6Y1QGt9O)”
      },
    ],
  “location:”: “”,
  “sensorId:”: “48105811”,
  “sensorToken:”: “NsMD3f1XW5fHVOkuGlqX”,
  “location:”: “42.8954135,−72.0153846,14z”,
  “requireBiometricAuthenticationStatus”: true,
  “maximumBiometricAuthenticationTimeDifference”: “108000”
}
```

In some aspects, the object illustrated in Table 4 above includes a list of authentication data that includes a frame identifier, a hashed biometric identifier, a timestamp of the frame, and frame data. The frame data can correspond to the regions of the biometric information that can be used to authenticate the first person 920 and the second person 922. The control system also generates and transmits an authentication request 926 to authenticate the user associated with the user device 906. The authentication request 926 can include the authentication data identified in Table 4 because each user device will identify the data corresponding to the user.

The user device 904 receives the authentication request 924 and, in response, determines a biometric authentication status and performs a biometric authentication at the user device 904 using the captured biometric information 918 (e.g., using the frame data illustrated in Table 4 above) at block 928. In some aspects, the authentication request 924 includes a maximum biometric authentication time difference in milliseconds that requires the user to have biometrically authenticated within this time (30 minutes). If the user of the user device 904 has not performed a biometric authentication within this time, the user device 904 can require a biometric authentication to authenticate the user. The user device 906 receives the authentication request 926 and, in response, determines a biometric authentication status and performs a biometric authentication at block 930.

The user device 904 transmits an authentication response 932 that identifies the authentication data in the authentication request 924 that matches the user of the user device. An example authentication response 932 identifying the first person is illustrated in Table 5 below.

TABLE 5

```
{
  “authenticationId”: “9”,
  “hashedBiometricIdentifer”:“BmRH0b4IspEetFUayAiB”,
  “imsi”: “900290634881”,
  “macAddress”: “00-00-00-00-00-00-00”,
  “capturedBiometricVerificationResult”: true,
  “biometricAuthenticationTimes”:
  [
    “2021-12-12T06:56:52+0000”,
    “2021-12-12T04:56:52+0000”,
    “2021-12-11T17:42:52+0000”
  ],
  “userId”: “ajJx5jc7x18kZTdQlCzq”,
}
```

The authentication response 932 in Table 5 provides information to map to the authentication data provided in the authentication request 926. The user device 906 transmits an authentication response 934 that identifies the authentication data in the authentication request 924 that matches the user of the user device 906. An example authentication response 934 identifying the second person is illustrated in Table 6 below.

TABLE 6

```
{
  “authenticationId”: “2”,
  “hashedBiometricIdentifer”:“Uzwhb5UpdBgTsIsRww3T”,
  “imsi”: “04749284881”,
  “macAddress”: “11-11-11-11-11-11-11”,
  “capturedBiometricVerificationResult”: true,
  “biometricAuthenticationTimes”:
  [
    “2021-12-11T06:56:52+0000”
  ],
  “userId”: “9yLAS9X5T88DrbpeJEny”,
}
```

The control system 902 determines whether to authenticate the users based on the biometric authentication responses at block 936. In particular, the control system 902 identifies a number of people associated and determines if each person is authenticated by a distinct user device. In this example, the control system 902 identified the first person 920 and the authentication response 932 uniquely identifies authentication data (e.g., the authenticationId having a value of 9) that maps the user device 904 to the first person 920 in the biometric information 918. The control system 902 also identified the second person 922 and the authentication response 932 uniquely identifies authentication data (the authenticationId having a value of 2) that maps the user device 906 to the second person 922 in the biometric information 918.

In some aspects, the control system 902 performs the function based on whether each person is identified. In this case, the control system 902 can detect proximity of multiple people, either via the biometric information 918 or based on a number of devices that are connected to the access point of the control system 902 and determined to be within a sufficient range. The control system 902 can control the function based on each user's authentication, which is an enhancement over some security access processes that only require a single authentication.

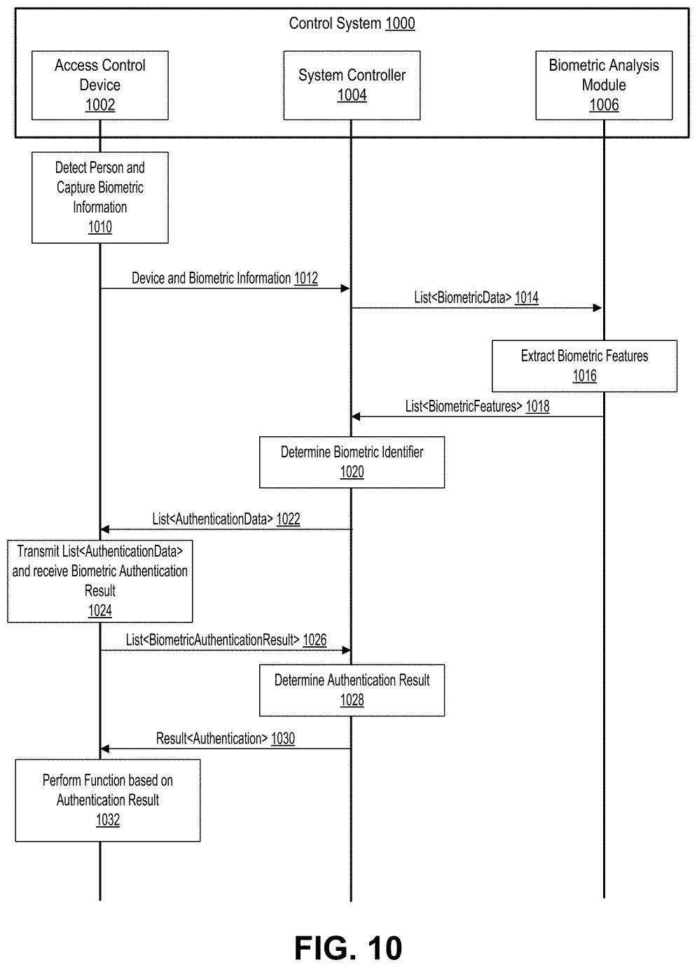

FIG. 10 illustrates an example sequence diagram of a heterogenous authentication process performed by a control system 1000. The control system 1000 includes an access control device 1002 that controls a function associated with the system (e.g., a door, a ticketing kiosk, etc.), a system controller 1004 that controls the overall system operations, and a biometric analysis module 1006 that extracts features from biometric data. The biometric analysis module 1006 may be a separate device or may be functions executed by the system controller 1004 and is illustrated to identify the functionality of the control system 1000.

The access control device 1002 may include a sensor (not shown) configured to detect biometric information such as an image sensor and a communication module (not shown) configured to communicate with a user device. The access control module is configured to detect a person and capture biometric information within a detection range of the access control device 1002 at block 1010. In some aspects, the access control device 1002 may be able to sense presence of a person outside of the detection range and monitor if that person enters within the detection range. This may indicate that the person intends to access the function associated with the access control device 1002. The access control device 1002 may also detect device information associated with the user device that the user is carrying.

The access control device 1002 may transmit device and biometric authentication information 1012 to the system controller 1004, which transmits a biometric analysis request including a list of biometric data 1014 to the biometric analysis module 1006. FIG. 10 illustrates the type of data illustrated in generic format G<T> with G being a generic type and T being the type consumed by that generic. As an example, the biometric analysis request includes a List<BiometricData> object, which indicates a generic list of type BiometricData (e.g., an array of BiometricData), and the BiometricData can include a portion of the captured image that corresponds to a person's face. At block 1016, the biometric analysis module 1006 extract biometric features and transmits a list of biometric features 1018 to the system controller 1004. The system controller 1004 determines biometric identifiers at block 1020 by combining a portion of the biometric features with unique information available to the system controller 1004 such as a user identifier, a hardware identifier, etc. The system controller 1004 then generates a list of authentication data 1022 and transmits that data to the access control device 1002. The list of authentication data can include the list of biometric data

The access control device 1002 transmits the list of authentication data 1022 to each device connected to the access control device 1002 and receives a biometric authentication result at block 1024. The access control device 1002 generates and transmits a list of biometric authentication results 1026, which each biometric authentication result corresponding to a user device, to the system controller 1004. The system controller 1004 determines an authentication result at block 1028 and transmits a result of the authentication 1030 to the access control device 1002, which performs the function associated with the access control device 1002 based on the authentication result at block 1032. For example, the access control device 1002 is associated with a door, the access control device 1002 will unlock the door if the user is authenticated and will maintain the locked state of the door if the user is not authenticated.

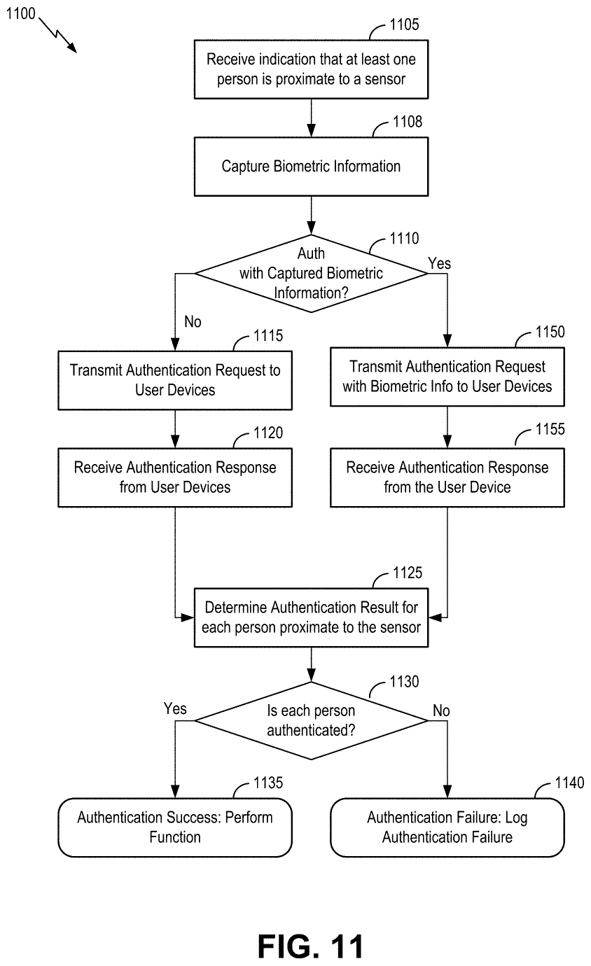

FIG. 11 illustrates an example process 1100 of a control system for performing a biometric authentication by employing a user device to perform biometric authentication. Although the example process 1100 depicts a particular sequence of operations, the sequence may be altered without departing from the scope of the present disclosure. For example, some of the operations depicted may be performed in parallel or in a different sequence that does not materially affect the function of the process 1100. In other examples, different components of an example device or system that implements the process 1100 may perform functions at substantially the same time or in a specific sequence. In some aspects, the process 1100 can be performed by a control system (e.g., the control system 1000) in conjunction with various parts of the system (e.g., the access control device 1002, the system controller 1004, etc.).

According to some examples, the process 1100 includes receiving indication (e.g., by the system controller 1004) at least one person is proximate to a sensor (e.g., the access control device 1002) at block 1105. For example, the access control device 1002 may broadcast a beacon with information from a communication device of the control system, receive a response from a user device, and determine that the user device is within a particular range from a sensor (e.g., the access control device 1002). In some aspects, the access control device 1002 may determine the number of people proximate to the communication device based on at least one response to the beacon.

After determining that the user device is within a particular range from a sensor, the process 1100 captures biometric information using an image sensor at block 1108. For example, the access control device 1002 may capture an image of at least one person proximate to the access control device 1002 and extract biometric information associated with the at least one person. The biometric information extraction may include identifying each face in the captured image and extracting different regions used for facial identification.

At block 1110, the process 1100 determines (e.g., by the system controller 1004) whether the indication includes a request to authenticate the user based on captured biometric information.

If it is determined that captured biometric information is not used in the authentication at block 1110, the process 1100 transmits (e.g., by the access control device 1002) an authentication request to any user devices to be authenticated at block 1115. In response, the user device determines of authentication without any captured biometric information from the control system. In some aspects, the user may be required to perform a biometric authentication, a password-based authentication, etc. The process 1100 includes receiving (e.g., by the access control device 1002) authentication responses from devices at block 1120.

The process 1100 determines (e.g., by the system controller 1004) whether each person proximate to the sensor is authenticated by the corresponding user device at block 1125. The authenticated can be identified at least in part based on a biometric authentication that is performed at the user device in response to the authentication request. In some aspects, the authentication can be based on a determination that the authentication status indicates the previous biometric authentication occurred at the first device within the time period before the first time period, determining a first identifier in the authentication response corresponds to a second identifier associated with user information stored by the control system.

In some examples of block 1125, the first and second identifiers can be hashed to verify a message transmitted between the user device and control system. For example, at block 1125, the process 1100 can identify first user information of the first person that is stored in the control system and cryptographically hash a biometric-based identifier stored with the first user information using a time-domain function (e.g., a salted hash) to yield the second identifier. When the first identifier in the authentication response corresponds to the second identifier, then the veracity of the message is verified.

If each person is authenticated, the process 1100 proceeds to block 1130 to determine whether each person proximate to the sensor is authenticated.

If each person is authenticated, the process 1100 proceeds to block 1135 to determine that authentication is successful, and a function is performed at block 1135. In some aspects, the function is a supplemental authentication in a multiple authentication system, an access request to a restricted area, a financial transaction associated with a service, or an access event to a common area. If the authentication fails at block 1130, the process 1100 proceeds to block 1140 where authentication fails, and a log entry is generated to identify the authentication failure. In this example, each user is required to be authenticated but other examples may require at least one person to be authenticated.

Referring back to block 1110, if it is determined that captured biometric information is used in the authentication, the process 1100 transmits (e.g., by the access control device 1002) an authentication request to any user devices to be authenticated at block 1150. The authentication request may include the extracted biometric information (e.g., the cropped regions of the captured image that correspond to a face). In some examples, the authentication request may include information related to an authentication status at the user device that can be used to determine that the person was recently authenticated.

In some aspects, the authentication request can be split into two separate messages. The first message can request the authentication status at the user device and, if the user device responds with information that indicates that the person associated with the user device has successfully biometrically authenticated with the user device, a second message including the biometric information may be transmitted to the user device.

In response to the authentication request, the process 1100 receives an authentication response from the first device at block 1155. In some aspects, the authentication response includes a result of a biometric authentication performed at the first device. The biometric authentication can be a biometric authentication of the captured biometric information, which indicates that the person in the captured biometric information at block 1108 corresponds to a user of the user device. In other examples, the biometric authentication can also be a biometric authentication that is performed in response to the authentication request transmitted at block 1150. The authentication response may include an authentication status indicating that a previous biometric authentication of the person occurred at the user device within a time period.

After receiving the authentication responses from the user devices at block 1155, the process proceeds to block 1125 to determine an authentication result for each person proximate to the sensor and determine whether authentication succeeds or fails in blocks 1130, 1135, and 1140.

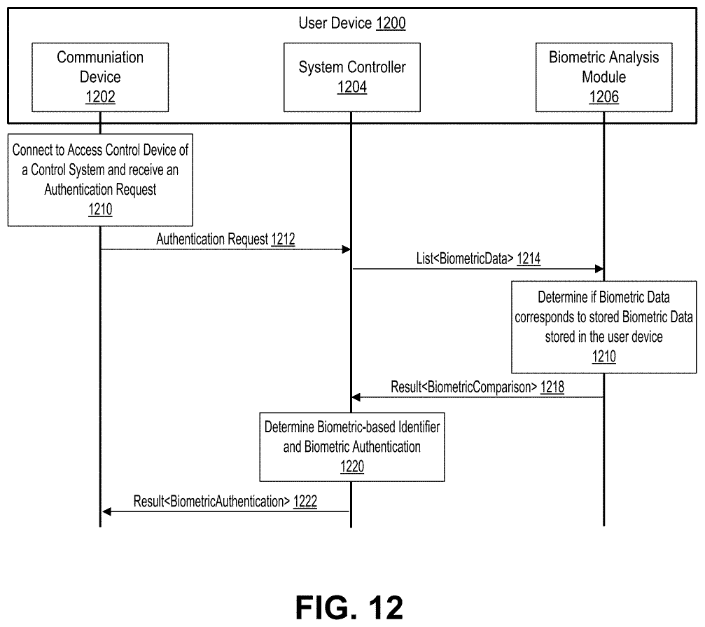

FIG. 12 illustrates an example sequence diagram of a heterogenous authentication process performed by a user device 1200. The user device includes a communication module 1202, a system controller 1204, and a biometric analysis module 1206. The biometric analysis module may be a separate device or may be functions executed by the system controller 1204 and is illustrated to clearly identify functionality of the user device 1200. The communication module can receive a beacon from an access control module, connect to the control system via the access control module, and receive an authentication request 1212 transmitted by the access control module at block 1210. The communication module 1202 transmits the authentication request 1212 to the system controller 1204. The authentication request 1212 can include a list of authentication data, and each authentication data can include biometric data captured by the access control module.

The system controller 1204 transmits a list of biometric data (e.g., at least one face captured by the access control device of the control system) to the biometric analysis module 1206 to authenticate biometric data. In some aspects, the biometric analysis module 1206 can access securely encrypted biometric information that is captured at the user device 1200 (e.g., a picture of the user) and identify whether any of the biometric data corresponds to the user at block 1210. The biometric analysis module 1206 generates and transmits a result of the biometric comparison 1218 to the system controller 1204. The biometric comparison result can include biometric features used to generate the biometric-based identifier. At block 1220, the system controller 1204 determines the biometric-based identifier and determines a biometric authentication result 1222 using the biometric authentication result and other information (e.g., biometric authentication status, etc.). The system controller 1204 generates an authentication response including the biometric authentication result 1222 that was determined at block 1220.

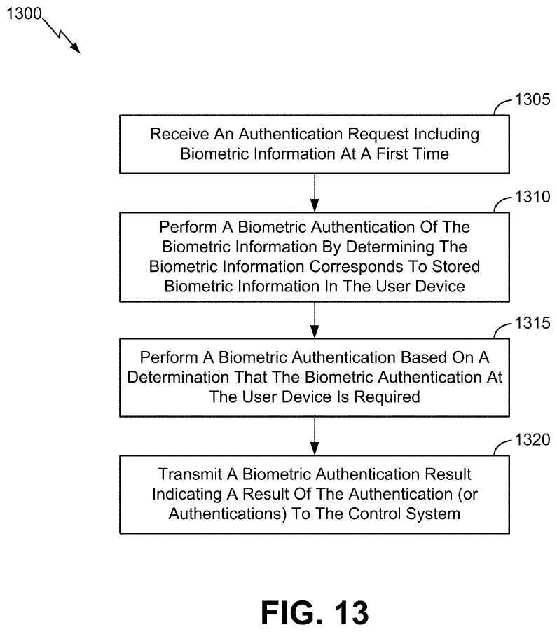

FIG. 13 is a flowchart illustrating an example of an authentication process that can be performed by a user device. Although the example process 1300 depicts a particular sequence of operations, the sequence may be altered without departing from the scope of the present disclosure. For example, some of the operations depicted may be performed in parallel or in a different sequence that does not materially affect the function of the process 1300. In other examples, different components of an example device or system that implements the process 1300 may perform functions at substantially the same time or in a specific sequence. In some aspects, the process 1300 can be performed by a user device (e.g., the mobile device 102) that includes a biometric authentication function to authenticate the user of the user device.

In some aspects, the process 1300 includes receiving (e.g., by the mobile device 102) an authentication request including biometric information at a first time period at block 1305. In response to the authentication request, the process includes performing (e.g., by the mobile device 102) a biometric authentication of the biometric information by determining the biometric information corresponds to stored biometric information in the user device at block 1310. The biometric information includes information associated with a different person detected by the control system. Another example of the biometric authentication at block 1310 may include determining an authentication status indicating a previous biometric authentication occurred at the user device within a time period before the first time period.

According to some examples, the process includes performing a biometric authentication (e.g., facial recognition, fingerprint recognition) based on a determination that the biometric authentication at the user device is required block 1315. If the biometric authentication is required, the user provides an input at the user device and the user device determines a biometric authentication result.

In some aspects, the process comprises transmitting a biometric authentication result indicating a result of the authentication (or authentications) to the control system. As part of generating the biometric authentication result, block 1320 can include generating a biometric-based identifier at least in part by combining the biometric information with identification information. In some aspects, the biometric-based identifier can be generated by the user device by hashing the biometric-based identifier based on a time-domain function.

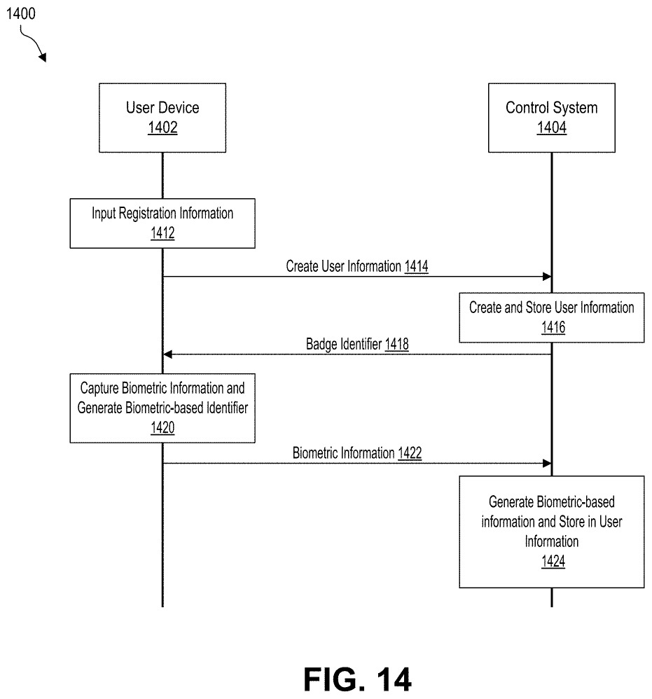

FIG. 14 is a sequence diagram of a process 1400 to register user biometrics that can be used in a heterogeneous authentication system. The user device 1402 can be configured to connect with a control system 1404. In some aspects, the user device 1402 can be a user device configured that performs functions within a private location (e.g., within a corporate intranet), or can be connected to a physical system employed at a physical location (e.g., an on-premises kiosk).

At block 1412, the user device 1402 receives input of user information associated with registration of a user account (e.g., user information), and the user information is transmitted to the control system 1404 in a create user information request 1414. The control system 1404 creates and stores user information, including private data such as user identifiers, etc. In some aspects, the control system 1404 may create a badge identifier 1418 (e.g., a unique user token) and transmit the badge identifier 1418 to the user device 1402.

As part of the registration process, the user device 1402 or another device (e.g., a kiosk) of the registration process may capture biometric information and generate a biometric-based identifier at block 1420, and the user device 1402 may store the biometric-based identifier. In some aspects, the user device can use stored biometric information and the captured biometric information as inputs into a biometric feature extraction algorithm to determine whether the captured biometric information is sufficiently accurate. The user device generates a biometric information message 1422 that includes the biometric information to the control system 1404. In some aspects, various techniques can be employed to separately capture the biometric information and relay that biometric information to the control system 1404.

At block 1424, the control system 1404 generates biometric-based information from the biometric information in the biometric information message 1422 and stores the biometric-based information in the user information. In some aspects, the process 1400 can include performing a separate verification of the biometric-based information by performing a separate communication with the control system 1404 using, for example, a different communication technique. For example, the user device can generate a quick response (QR) code that corresponds to the hashed biometric identifier, and that QR code can be transmitted to the control system 1404 to authenticate the registration process.

The process 1400 illustrates that the biometric information is not shared with the control system and only biometric-based information is provided to the control system 1404 a single time. The biometric-based identifiers are separately generated by the user device 1402 and the control system 1404 during enrollment and provides an extra layer of security to the heterogeneous authentication process.

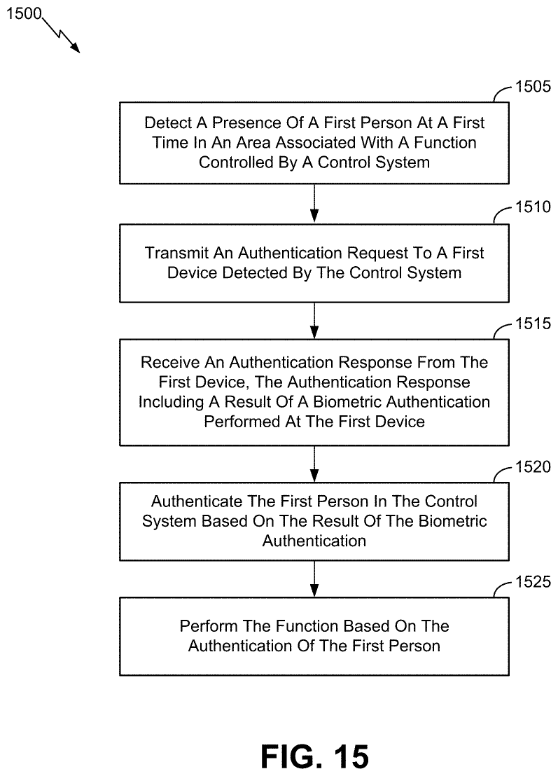

FIG. 15 is a flowchart illustrating an example of a process 1500 for performing biometric authentication in a control system. The process 1500 can be performed by a computing device or apparatus, in conjunction with various devices (e.g., sensors) to identify and authorize users. For instance, as described above, the computing device or apparatus can operate as a control system when performing the process 1500.

At block 1505, the computing device may detect the presence of a first person at a first time period and in an area associated with a function controlled by a control system. In some aspects, the function is a supplemental authentication in a multiple authentication system, an access request to a restricted area, a financial transaction associated with a service, or an access event to a common area. The computing device can use a sensor (e.g., an image sensor, a motion sensor, a wireless communication device, etc.) to detect the presence of the first person.

In one illustrative example, the computing device may capture an image of the first person with an image sensor and extract biometric information of the first person from the image. In some cases, the biometric information includes facial information of the first person. As described above, the computing device may combine the biometric information with unique identifying information to generate a biometric-based identifier that is unique.

In another illustrative example, the computing device may broadcast a beacon with information from a communication device of the control system. For example, a wireless communication module near the function can broadcast a beacon such as an 802.11k beacon, or a Bluetooth beacon. Based on responses to the beacon, the computing device may determine the number of people proximate to the communication device based on at least one response to the beacon. In some cases, the function is performed when a number of user devices that are authenticated by the control system is equal to the number of people proximate to the communication device. In other cases, the function is not performed when a number of user devices that are authenticated by the control system is different than the number of people proximate to the communication device.

At block 1510, the computing device may transmit an authentication request to a first device detected by the control system. In some aspects, the authentication request includes biometric information of the first person. In other aspects, the authentication request can include additional information such as supplemental information related to a number of authentications performed at the first device within a time period, which can indicate that the person possessing the first device corresponds to the first person.

At block 1515, the computing device may receive an authentication response from the first device, the authentication response including information related to a biometric authentication performed at the first device. In some aspects, the authentication response may include an authentication status indicating that a previous biometric authentication of the first person occurred at the first device within a time period before the first time period (e.g., at least one biometric authentication within the last 30 minutes). In some aspects, based on a determination that the authentication status indicates the previous biometric authentication occurred at the first device within the time period before the first time period, the computing device may determine a first identifier in the authentication response corresponds to a second identifier associated with user information stored by the control system. In some aspects, based on a determination that the authentication status indicates the biometric information was not used to authenticate the first person within the time period before the first time period, transmitting an authentication request to the first device to cause the first device to perform a biometric authentication of the first person using an input into the first device. In some cases, in response to the authentication status indicating the biometric information was used to authenticate the first person within the time period before the first time period, transmitting an authentication request to the first device including the biometric information.

In some cases, the authentication response may include a first identifier determined at the first device and the computing device may determine if the first identifier corresponds to the second identifier associated with user information stored by the control system. For instance, the first identifier may be a biometric-based identifier that is determined based on the captured image and the second identifier may be the stored biometric identifier, which may authenticate the first person. In one illustrative example, the computing device may generate the second identifier by cryptographically hashing a biometric-based identifier associated with the first person. In some aspects, the second identifier is generated based on a determination that the authentication response indicates the biometric information in the authentication request corresponds to stored biometric information in the first device. In some cases, the generating the second identifier (e.g., using the cryptographically hashing function) may be performed based on a time domain function. For example, the time domain function can be a rotation of a key or a salt that is changed at a time interval (e.g., 5 minutes) that would cause an identifier to expire every time interval. Based on identification of the biometric identifier, the computing device may identify first user information of the first person and retrieve, for example, authorization information to access a location, a balance (e.g., for a ticketing system), and so forth.

At block 1520, the computing device may authenticate the first person in the control system based on the information related to the biometric authentication. At block 1525, the computing device may performing the function based on the authenticating of the first person. In some aspects, the computing device may detect the presence of a second person, either in the captured image or through another mechanism (e.g., a wireless beacon). The computing device may control or authorize the function to be performed based on the authentication of a single user (e.g., the first person), or the authentication of multiple users (e.g., the first person and the second person). For example, the function may be performed when the first person and the second person are authenticated and may not be performed when the first person or the second person is not authenticated. In this manner, the computing device may prevent unauthorized access to the associated function such as a restricted area within a business entity.

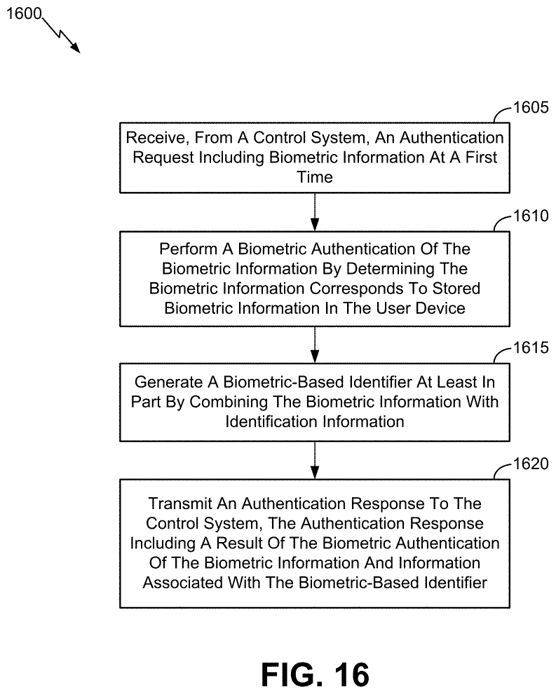

FIG. 16 is a flowchart illustrating an example of a process 1600 for performing biometric authentication by a user device. The process 1600 can be performed by a user device or a mobile device having authentication capabilities. For instance, as described above, the computing device or apparatus can operate as a user device interacting with a control system for authentication when performing the process 1600.

At block 1605, the computing device may receive, from a control system, an authentication request including biometric information at a first time period. In some aspects, the authentication request is received based on proximity to a sensor of a control system. For example, the control system may detect motion associated with proximate to the sensor, may detect wireless signals that are responsive to a beacon, or may identify at least one person from images detected by an image sensor. In other examples, the person may activate a fingerprint sensor, which detects the proximity of the person.

At block 1610, the computing device may perform a biometric authentication of the biometric information by determining the biometric information corresponds to stored biometric information in the user device. In some aspects, an image sensor that is proximate to the function may capture an image of the person and transmit biometric information to a device associated with the person.

In one illustrative example, the biometric authentication can also request prior authentications performed at the computing device within a time period (e.g., 30 minutes). The authentications provide supplemental authentication information separate from the control system and improves security. In other aspects, the biometric authentication can request that the user perform a biometric authentication at the computing system.

At block 1615, the computing device may generate a biometric-based identifier at least in part by combining the biometric information with identification information. In this aspect, the identification information is stored in the computing system and is not directly shared because it is combined with biometric information.

At block 1620, the computing device may transmit an authentication response to the control system, the authentication response including information related to the biometric authentication of the biometric information and information associated with the biometric-based identifier. In some examples, the computing device may generate the information associated with the biometric-based identifier by hashing the biometric-based identifier based on a time domain function. The control system uses the authentication response to verify the person presently possessing the computing device corresponds to the person's biometric information in the computing system and then authorizes the person based on the function.

In some aspects, the computing device may determine an authentication status indicating a previous biometric authentication occurred at the user device within a time period before the first time period. In some cases, the computing device may receive a request to perform biometric authentication at the user device. The computing device may request biometric authentication at the user device and may perform the biometric authentication at the user device based on an input. The computing device may transmit information related to the biometric authentication at the user device to the control system.

In some examples, the computing device may receive biometric information of a first person during registration of first user information corresponding to a first user associated with the authentication request. The computing device may generate the biometric-based identifier at least in part by combining a portion of features from the biometric information. The computing device may transmit the biometric-based identifier to the control system.

In some examples, the processes described herein (e.g., process 300, 400, 1100, 1300, 1400, 1500, 1600, and/or other process described herein) may be performed by a computing device or apparatus. In one example, the process 1300 can be performed by a computing device (e.g., mobile device 102 in FIG. 1) having a computing architecture of the computing system 1700 shown in FIG. 17.

The computing device can include any suitable device, such as a mobile device (e.g., a mobile phone), a desktop computing device, a tablet computing device, a wearable device (e.g., a virtual reality (VR) headset, an augmented reality (AR) headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 400 and process 1300. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 300, 400, 1100, 1300, 1400, 1500, and 1600 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The processes 300, 400, 1100, 1300, 1400, 1500, 1600, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 17 is a diagram illustrating an example of a system for implementing certain aspects of the present technology. In particular, FIG. 17 illustrates an example of computing system 1700, which can be for example any computing device making up internal computing system, a remote computing system, a camera, or any component thereof in which the components of the system are in communication with each other using connection 1705. Connection 1705 can be a physical connection using a bus, or a direct connection into processor 1710, such as in a chipset architecture. Connection 1705 can also be a virtual connection, networked connection, or logical connection.

In some aspects, computing system 1700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1700 includes at least one processing unit (CPU or processor) 1710 and connection 1705 that couples various system components including system memory 1715, such as read-only memory (ROM) 1720 and random access memory (RAM) 1725 to processor 1710. Computing system 1700 can include a cache 1712 of high-speed memory connected directly with, in close proximity to, or integrated as part of processor 1710.

Processor 1710 can include any general purpose processor and a hardware service or software service, such as services 1732, 1734, and 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric.

To enable user interaction, computing system 1700 includes an input device 1745, which can represent any number of input mechanisms, such as a microphone for speech, a touch-sensitive screen for gesture or graphical input, keyboard, mouse, motion input, speech, etc. Computing system 1700 can also include output device 1735, which can be one or more of a number of output mechanisms. In some instances, multimodal systems can enable a user to provide multiple types of input/output to communicate with computing system 1700. Computing system 1700 can include communications interface 1740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, wireless local area network (WLAN) signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1740 may also include one or more Global Navigation Satellite System (GNSS) receivers or transceivers that are used to determine a location of the computing system 1700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1730 can include software services, servers, services, etc., that when the code that defines such software is executed by the processor 1710, it causes the system to perform a function. In some aspects, a hardware service that performs a particular function can include the software component stored in a computer-readable medium in connection with the necessary hardware components, such as processor 1710, connection 1705, output device 1735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a process embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a process, a function, a procedure, a subroutine, a subprogram, etc. When a process corresponds to a function, its termination can correspond to a return of the function to the calling function or the main function.

Processes and processes according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during processes according to described examples include magnetic or optical disks, flash memory, USB devices provided with non-volatile memory, networked storage devices, and so on.

Devices implementing processes and processes according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, processes were described in a particular order. It should be appreciated that in alternate aspects, the processes may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative examples of the disclosure include:

Aspect 1: A method of performing biometric authentication at a control system, the method comprising: detecting the presence of a first person at a first time period and in an area associated with a function controlled by a control system; transmitting an authentication request to a first device detected by the control system; receiving an authentication response from the first device, the authentication response including information related to a biometric authentication performed at the first device; authenticating the first person in the control system based on the information related to the biometric authentication; and performing the function based on the authenticating of the first person.

Aspect 2: The method of Aspect 1, further comprising: capturing an image of the first person with an image sensor; and extracting biometric information of the first person from the image.

Aspect 3: The method of any of Aspects 1 to 2, wherein the biometric information includes facial information of the first person.

Aspect 4: The method of any of Aspects 1 to 3, further comprising: identifying a second person in the image, wherein authenticating of the first person is further based on an authentication of the second person, and wherein the function is performed based on whether the first person and the second person are authenticated.

Aspect 5: The method of any of Aspects 1 to 4, further comprising extracting facial information of the second person from the image.

Aspect 6: The method of any of Aspects 1 to 5, wherein the function is performed when the first person and the second person are authenticated.

Aspect 7: The method of any of Aspects 1 to 6, wherein the authentication request includes biometric information of the first person.

Aspect 8: The method of any of Aspects 1 to 7, wherein the authentication response includes an authentication status indicating that a previous biometric authentication of the first person occurred at the first device within a time period before the first time period.

Aspect 9: The method of any of Aspects 1 to 8, further comprising: based on a determination that the authentication status indicates the previous biometric authentication occurred at the first device within the time period before the first time period, determining a first identifier in the authentication response corresponds to a second identifier associated with user information stored by the control system.

Aspect 10: The method of any of Aspects 1 to 9, further comprising: generating the second identifier by cryptographically hashing a biometric-based identifier associated with the first person.

Aspect 11: The method of any of Aspects 1 to 10, wherein the second identifier is generated based on a determination that the authentication response indicates the biometric information in the authentication request corresponds to stored biometric information in the first device.

Aspect 12: The method of any of Aspects 1 to 11, wherein the generating is performed based on a time domain function.

Aspect 13: The method of any of Aspects 1 to 12, further comprising: identifying first user information of the first person, wherein the first user information includes the biometric-based identifier.

Aspect 14: The method of any of Aspects 1 to 13, further comprising: based on a determination that the authentication status indicates the biometric information was not used to authenticate the first person within the time period, transmitting an authentication request to the first device to cause the first device to perform a biometric authentication of the first person using an input into the first device.

Aspect 15: The method of any of Aspects 1 to 14, further comprising: receiving biometric information of the first person during registration of the first user information; generating the biometric-based identifier at least in part by combining a portion of features from the biometric information; and transmitting the biometric-based identifier to the control system.

Aspect 16: The method of any of Aspects 1 to 15, further comprising: receiving a first response to the authentication request including an authentication status indicating biometric information was used to authenticate the first person within a time period before the first time period; and transmitting an authentication request to the first device including the biometric information.

Aspect 17: The method of any of Aspects 1 to 16, wherein detecting the presence of the first person comprises: broadcasting a beacon with information from a communication device of the control system; and determining a number of people proximate to the communication device based on at least one response to the beacon, wherein the function is performed based on the number of people proximate to the communication device.

Aspect 18: The method of any of Aspects 1 to 17, wherein the function is performed when a number of user devices that are authenticated by the control system is equal to the number of people proximate to the communication device.

Aspect 19: The method of any of Aspects 1 to 18, wherein the function is not performed when a number of user devices that are authenticated by the control system is different than the number of people proximate to the communication device.

Aspect 20: The method of any of Aspects 1 to 19, wherein the function is a supplemental authentication in a multiple authentication system, an access request to a restricted area, a financial transaction associated with a service, or an access event to a common area.

Aspect 21: A method of performing biometric authentication at a user device, the method comprising: receiving, from a control system, an authentication request including biometric information at a first time period; performing a biometric authentication of the biometric information by determining the biometric information corresponds to stored biometric information in the user device; generating a biometric-based identifier at least in part by combining the biometric information with identification information; and transmitting an authentication response to the control system, the authentication response including information related to the biometric authentication of the biometric information and information associated with the biometric-based identifier.

Aspect 22: The method of Aspect 21, further comprising: generating the information associated with the biometric-based identifier by hashing the biometric-based identifier based on a time domain function.

Aspect 23: The method of any of Aspects 21 to 22, further comprising: determining an authentication status indicating a previous biometric authentication occurred at the user device within a time period before the first time period.

Aspect 24: The method of any of Aspects 21 to 23, wherein the authentication request is received based on proximity to a sensor of a control system.

Aspect 25: The method of any of Aspects 21 to 24, further comprising: receiving a request to perform biometric authentication at the user device; requesting biometric authentication at the user device; performing the biometric authentication at the user device based on an input; and transmitting information related to the biometric authentication at the user device to the control system.

Aspect 26: The method of any of Aspects 21 to 25, wherein the biometric information includes information associated with a different person detected by the control system.

Aspect 27: A system for performing biometric authentication including a memory (e.g., implemented in circuitry) and a processor (or multiple processors) coupled to the memory. The processor (or processors) is configured to: detect the presence of a first person at a first time period and in an area associated with a function controlled by a control system; transmit an authentication request to a first device detected by the control system; receive an authentication response from the first device, the authentication response including Information related to a biometric authentication performed at the first device; authenticate the first person in the control system based on the information related to the biometric authentication; and perform the function based on the authenticating of the first person.

Aspect 28: The system of Aspect 27, wherein the processor is configured to: capture an image of the first person with an image sensor; and extract biometric information of the first person from the image.

Aspect 29: The system of any of Aspects 27 to 28, wherein the biometric information includes facial information of the first person.

Aspect 30: The system of any of Aspects 27 to 29, wherein the processor is configured to: identify a second person in the image, wherein authenticating of the first person is further based on an authentication of the second person.

Aspect 31: The system of any of Aspects 27 to 30, wherein the processor is configured to: extract facial information of the second person from the image.

Aspect 32: The system of any of Aspects 27 to 31, wherein the function is performed when the first person and the second person are authenticated.

Aspect 33: The system of any of Aspects 27 to 32, wherein the authentication request includes biometric information of the first person.

Aspect 34: The system of any of Aspects 27 to 33, wherein the authentication response includes an authentication status indicating that a previous biometric authentication of the first person occurred at the first device within a time period before the first time period.

Aspect 35: The system of any of Aspects 27 to 34, wherein based on a determination that the authentication status indicates the previous biometric authentication occurred at the first device within the time period before the first time period, determine a first identifier in the authentication response corresponds to a second identifier associated with user information stored by the control system.

Aspect 36: The system of any of Aspects 27 to 35, wherein the processor is configured to: generate the second identifier by cryptographically hashing a biometric-based identifier associated with the first person.

Aspect 37: The system of any of Aspects 27 to 36, wherein the second identifier is generated based on a determination that the authentication response indicates the biometric information in the authentication request corresponds to stored biometric information in the first device.

Aspect 38: The system of any of Aspects 27 to 37, wherein the generating is performed based on a time domain function.

Aspect 39: The system of any of Aspects 27 to 38, wherein The method of claim 10 11, further comprising: identify first user information of the first person, wherein the first user information includes the biometric-based identifier.

Aspect 40: The system of any of Aspects 27 to 39, wherein the processor is configured to: based on a determination that the authentication status indicates the biometric information was not used to authenticate the first person within the time period, transmit an authentication request to the first device to cause the first device to perform a biometric authentication of the first person using an input into the first device.

Aspect 41: The system of any of Aspects 27 to 40, wherein the processor is configured to: receive biometric information of the first person during registration of the first user information; generate the biometric-based identifier at least in part by combining a portion of features from the biometric information; and transmit the biometric-based identifier to the control system.

Aspect 42: The system of any of Aspects 27 to 41, wherein the processor is configured to: receive a first response to the authentication request including an authentication status indicating biometric information was used to authenticate the first person within a time period before the first time period; and transmit an authentication request to the first device including the biometric information.

Aspect 43: The system of any of Aspects 27 to 42, wherein the processor is configured to: broadcast a beacon with information from a communication device of the control system; and determine a number of people proximate to the communication device based on at least one response to the beacon, wherein the function is performed based on the number of people proximate to the communication device.

Aspect 44: The system of any of Aspects 27 to 43, wherein the function is performed when a number of user devices that are authenticated by the control system is equal to the number of people proximate to the communication device.

Aspect 45: The system of any of Aspects 27 to 44, wherein the function is not performed when a number of user devices that are authenticated by the control system is different than the number of people proximate to the communication device.

Aspect 46: The system of any of Aspects 27 to 45, wherein the function is a supplemental authentication in a multiple authentication system, an access request to a restricted area, a financial transaction associated with a service, or an access event to a common area.

Aspect 47: An apparatus including a memory (e.g., implemented in circuitry) and a processor (or multiple processors) coupled to the memory. The processor (or processors) is configured to: receive, from a control system, an authentication request including biometric information at a first time period; perform a biometric authentication of the biometric information by determining the biometric information corresponds to stored biometric information in the user device; generate a biometric-based identifier at least in part by combining the biometric information with identification information; and transmit an authentication response to the control system, the authentication response including information related to the biometric authentication of the biometric information and information associated with the biometric-based identifier.

Aspect 48: The apparatus of Aspect 47, wherein the processor is configured to: generate the information associated with the biometric-based identifier by hashing the biometric-based identifier based on a time domain function.

Aspect 49: The apparatus of any of Aspects 47 to 48, wherein the processor is configured to: determine an authentication status indicating a previous biometric authentication occurred at the user device within a time period before the first time period.

Aspect 50: The apparatus of any of Aspects 47 to 49, wherein the authentication request is received based on proximity to a sensor of a control system.

Aspect 51: The apparatus of any of Aspects 47 to 50, wherein the processor is configured to: receive a request to perform biometric authentication at the user device; perform the biometric authentication based on an input; and transmit information related to the biometric authentication to the control system.

Aspect 52: The apparatus of any of Aspects 47 to 51, wherein the biometric information includes information associated with a different person detected by the control system.

Aspect 53: A non-transitory computer-readable medium having stored thereon instructions that, when executed by one or more processors, cause the one or more processors to perform operations according to any of Aspects 1 to 20.

Aspect 54: An apparatus for performing biometric authentication comprising one or more means for performing operations according to any of Aspects 1 to 20.

Aspect 55: A non-transitory computer-readable medium having stored thereon instructions that, when executed by one or more processors, cause the one or more processors to perform operations according to any of Aspects 21 to 26.

Aspect 56: An apparatus for performing biometric authentication comprising one or more means for performing operations according to any of Aspects 21 to 26.

What is claimed is:

1. A method of performing biometric authentication in a control system, the method comprising:
detecting the presence of a first person at a first time period and in an area associated with a function controlled by a control system;
transmitting an authentication request to a first device detected by the control system;
receiving an authentication response from the first device, the authentication response including information related to a biometric authentication performed at the first device;
authenticating the first person in the control system based on the information related to the biometric authentication; and
performing the function based on the authenticating of the first person.

2. The method of claim 1, further comprising:
capturing an image of the first person with an image sensor; and
extracting biometric information of the first person from the image.

3. The method of claim 2, wherein the biometric information includes facial information of the first person.

4. The method of claim 2, further comprising:
identifying a second person in the image, wherein authenticating of the first person is further based on an authentication of the second person, and wherein the function is performed based on whether the first person and the second person are authenticated.

5. The method of claim 4, further comprising extracting facial information of the second person from the image.

6. The method of claim 4, wherein the function is performed when the first person and the second person are authenticated.

7. The method of claim 1, wherein the authentication request includes biometric information of the first person.

8. The method of claim 1, wherein the authentication request includes biometric information of the first person, and wherein the authentication response includes an authentication status indicating that a previous biometric authentication of the first person occurred at the first device within a time period before the first time period.

9. The method of claim 8, further comprising:
based on a determination that the authentication status indicates the previous biometric authentication occurred at the first device within the time period before the first time period, determining a first identifier in the authentication response corresponds to a second identifier associated with user information stored by the control system.

10. The method of claim 9, further comprising:
generating the second identifier by cryptographically hashing a biometric-based identifier associated with the first person.

11. The method of claim 10, wherein the generating is performed based on a time domain function.

12. The method of claim 10, further comprising:
identifying first user information of the first person, wherein the first user information includes the biometric-based identifier.

13. The method of claim 9, wherein the second identifier is generated based on a determination that the authentication response indicates the biometric information in the authentication request corresponds to stored biometric information in the first device.

14. The method of claim 8, further comprising:
based on a determination that the authentication status indicates the biometric information was not used to authenticate the first person within the time period, transmitting an authentication request to the first device to cause the first device to perform a biometric authentication of the first person using an input into the first device.

15. The method of claim 1, further comprising:
receiving a first response to the authentication request including an authentication status indicating biometric information was used to authenticate the first person within a time period before the first time period; and
transmitting an authentication request to the first device including the biometric information.

16. The method of claim 1, wherein detecting the presence of the first person comprises:
broadcasting a beacon with information from a communication device of the control system; and
determining a number of people proximate to the communication device based on at least one response to the beacon, wherein the function is performed based on the number of people proximate to the communication device.

17. The method of claim 16, wherein the function is performed when a number of user devices that are authenticated by the control system is equal to the number of people proximate to the communication device.

18. The method of claim 16, wherein the function is not performed when a number of user devices that are authenticated by the control system is different than the number of people proximate to the communication device.

19. The method of claim 1, wherein the function is a supplemental authentication in a multiple authentication system, an access request to a restricted area, a financial transaction associated with a service, or an access event to a common area.

20. A method of performing biometric authentication by a user device, the method comprising:
receiving, from a control system, an authentication request including biometric information at a first time period;
performing a biometric authentication of the biometric information by determining the biometric information corresponds to stored biometric information in the user device;
generating a biometric-based identifier at least in part by combining the biometric information with identification information; and
transmitting an authentication response to the control system, the authentication response including information related to the biometric authentication of the biometric information and information associated with the biometric-based identifier.

21. The method of claim 20, further comprising:
generating the information associated with the biometric-based identifier by hashing the biometric-based identifier based on a time domain function.

22. The method of claim 20, further comprising:
determining an authentication status indicating a previous biometric authentication occurred at the user device within a time period before the first time period.

23. The method of claim 20, wherein the authentication request is received based on proximity to a sensor of a control system.

24. The method of claim 23, further comprising:
receiving a request to perform biometric authentication at the user device;
requesting biometric authentication at the user device;
performing the biometric authentication at the user device based on an input; and
transmitting information related to the biometric authentication at the user device to the control system.

25. The method of claim 20, wherein the biometric information includes information associated with a different person detected by the control system.

26. The method of claim 20, further comprising:
receiving biometric information of a first person during registration of first user information corresponding to a first user associated with the authentication request;
generating the biometric-based identifier at least in part by combining a portion of features from the biometric information; and
transmitting the biometric-based identifier to the control system.

27. A system for performing biometric authentication, comprising:
a memory; and
one or more processors coupled to the memory and configured to:
detect the presence of a first person at a first time period and in an area associated with a function controlled by a control system;
transmit an authentication request to a first device detected by the control system;
receive an authentication response from the first device, the authentication response including information related to a biometric authentication performed at the first device;
authenticate the first person in the control system based on the information related to the biometric authentication; and
perform the function based on the authenticating of the first person.

28. The system of claim 27, wherein the one or more processors are configured to:
capture an image of the first person with an image sensor; and
extract biometric information of the first person from the image.

29. The system of claim 28, wherein the biometric information includes facial information of the first person.

30. The system of claim 28, wherein the one or more processors are configured to:
identify a second person in the image, wherein authenticating of the first person is further based on an authentication of the second person, and wherein the function is performed based on whether the first person and the second person are authenticated.

31. The system of claim 30, wherein the one or more processors are configured to: extract facial information of the second person from the image.

32. The system of claim 30, wherein the function is performed when the first person and the second person are authenticated.

33. The system of claim 27, wherein the authentication request includes biometric information of the first person.

34. The system of claim 27, wherein the authentication request includes biometric information of the first person, and wherein the authentication response includes an authentication status indicating that a previous biometric authentication of the first person occurred at the first device within a time period before the first time period.

35. The system of claim 34, wherein the one or more processors are configured to:
based on a determination that the authentication status indicates the previous biometric authentication occurred at the first device within the time period before the first time period, determine a first identifier in the authentication response corresponds to a second identifier associated with user information stored by the control system.

36. The system of claim 35, wherein the one or more processors are configured to:
generate the second identifier by cryptographically hashing a biometric-based identifier associated with the first person.

37. The system of claim 36, wherein the generating is performed based on a time domain function.

38. The system of claim 36, wherein the one or more processors are configured to:
identify first user information of the first person, wherein the first user information includes the biometric-based identifier.

39. The system of claim 35, wherein the second identifier is generated based on a determination that the authentication response indicates the biometric information in the authentication request corresponds to stored biometric information in the first device.

40. The system of claim 34, wherein the one or more processors are configured to:
based on a determination that the authentication status indicates the biometric information was not used to authenticate the first person within the time period, transmit an authentication request to the first device to cause the first device to perform a biometric authentication of the first person using an input into the first device.

41. The system of claim 27, wherein the one or more processors are configured to:
receive a first response to the authentication request including an authentication status indicating biometric information was used to authenticate the first person within a time period before the first time period; and
transmit an authentication request to the first device including the biometric information.

42. The system of claim 27, wherein the one or more processors are configured to:
broadcast a beacon with information from a communication device of the control system; and
determine a number of people proximate to the communication device based on at least one response to the beacon, wherein the function is performed based on the number of people proximate to the communication device.

43. The system of claim 42, wherein the function is performed when a number of control systems that are authenticated by the control system is equal to the number of people proximate to the communication device.

44. The system of claim 42, wherein the function is not performed when a number of control systems that are authenticated by the control system is different than the number of people proximate to the communication device.

45. The system of claim 27, wherein the function is a supplemental authentication in a multiple authentication system, an access request to a restricted area, a financial transaction associated with a service, or an access event to a common area.

46. An apparatus for performing biometric authentication, comprising:
a memory; and
one or more processors coupled to the memory and configured to:
receiving, from a control system, an authentication request including biometric information at a first time period;
perform a biometric authentication of the biometric information by determining the biometric information corresponds to stored biometric information in the apparatus;
generate a biometric-based identifier at least in part by combining the biometric information with identification information; and
transmit an authentication response to the control system, the authentication response including information related to the biometric authentication of the biometric information and information associated with the biometric-based identifier.

47. The apparatus of claim 46, wherein the one or more processors are configured to:
generate the information associated with the biometric-based identifier by hashing the biometric-based identifier based on a time domain function.

48. The apparatus of claim 46, wherein the one or more processors are configured to: determine an authentication status indicating a previous biometric authentication occurred at the apparatus within a time period before the first time period.

49. The apparatus of claim 46, wherein the authentication request is received based on proximity to a sensor of a control system.

50. The apparatus of claim 49, wherein the one or more processors are configured to:
receive a request to perform biometric authentication at the apparatus;
perform biometric authentication based on an input; and
transmit information related to the biometric authentication to the control system.

51. The apparatus of claim 46, wherein the biometric information includes information associated with a different person detected by the control system.

52. The apparatus of claim 46, wherein the one or more processors are configured to:
receive biometric information of a first person during registration of first user information corresponding to a first user associated with the authentication request;
generate the biometric-based identifier at least in part by combining a portion of features from the biometric information; and
transmit the biometric-based identifier to the control system.
